(19) United States
(12) Patent Application Publication
(10) Pub. No.: US 2005/0016258 A1
(43) Pub. Date: Jan. 27, 2005

(54) Method for manufacturing a ceramic laminate

(75) Inventors: Kazunori Suzuki, Nagoya (JP); Namitsugu Fujii, Yokkaichi-shi (JP); Shoichiro Emmei, Nagoya (JP); Atsushi Iwata, Kuwana-shi (JP); Katsumi Kozaki, Mie-ken (JP); Yoshihiro Kinoshita, Kuwana-shi (JP)

Correspondence Address: NIXON & VANDERHYE, PC, 1100 N GLEBE ROAD, 8TH FLOOR, ARLINGTON, VA, 22201-4714, US

(73) Assignee: Denso Corporation, Aichi-pref. (JP)

(21) Appl. No.: 10/898,278

(22) Filed: Jul. 26, 2004

(30) Foreign Application Priority Data
Jul. 25, 2003 (JP) 2003-280353
Apr. 19, 2004 (JP) 2004-123159
May 25, 2004 (JP) 2004-154528

(51) Int. Cl. B32B 18/00; B32B 31/00

(52) U.S. Cl. 73/31.05; 156/89.11; 156/90; 428/212; 428/309.9; 428/312.2

(57) ABSTRACT

A ceramic laminate includes a first ceramic layer and a second ceramic layer which are laminated with each other via a bonding layer. The first ceramic layer has gas permeability. The second ceramic layer has gas impermeability. A method for forming this ceramic laminate includes a step of forming first and second ceramic layer forming green sheets, a step of coating a bonding layer forming paste on the second ceramic layer forming green sheet, and a step of integrally bonding the first ceramic layer forming green sheet with the bonding layer forming paste into a laminated body and then sintering the laminated body.

### BACKGROUND OF THE INVENTION

The present invention relates a method for manufacturing a ceramic laminate that includes a first ceramic layer and a second ceramic layer that are laminated with each other via a bonding layer. The first ceramic layer has gas permeability. The second ceramic layer has gas impermeability. The ceramic laminate manufactured according to this invention is used as a multilayered gas sensing element.

A multilayered gas sensing element generally consists of a plurality of ceramic layers.

For example, the Japanese patent application laid-open No. 2002-340848 discloses a conventional multilayered gas sensing element that includes a heater incorporating a heat-generating element, a spacer for defining a reference gas chamber, a solid electrolyte layer, a measured gas chamber defining spacer, a diffusion resistance layer, and a dense layer that are laminated with each other. A bonding layer intervenes between the heater and the reference gas chamber defining spacer. A bonding layer intervenes between the reference gas chamber defining spacer and the solid electrolyte layer. A bonding layer intervenes between the measured gas chamber defining spacer and the diffusion resistance layer.

The method for manufacturing this gas sensing element includes a step of bonding and integrating two green sheets via a bonding layer into a ceramic laminate being not sintered yet and a step of sintering this ceramic laminate. The diffusion resistance layer is a porous ceramic layer which is permeable against gas and water. The measured gas chamber defining spacer is a dense ceramic layer which is impermeable against gas and water.

However, the multilayered gas sensing element often causes cracks and chips due to the lack of durability. Eliminating these cracks and chips is important in assuring a long life time for the multilayered gas sensing element.

### SUMMARY OF THE INVENTION

The present invention relates to a method for manufacturing a ceramic laminate which causes substantially no cracks and chips and accordingly is capable of assuring excellent durability.

The present invention provides a first method for manufacturing a ceramic laminate including a first ceramic layer and a second ceramic layer which are laminated with each other via a bonding layer. The first ceramic layer has gas permeability. The second ceramic layer has gas impermeability. The first manufacturing method of this invention includes a first step of forming first and second ceramic layer forming green sheets, a second step of coating a bonding layer forming paste on the second ceramic layer forming green sheet, and a third step of integrally bonding the first ceramic layer forming green sheet with the bonding layer forming paste into a laminated body and then sintering the laminated body.

Inventors of this invention have concluded, based on the result of enthusiastically conducted researches and tests, that air bubbles residing along the boundary between the bonding layer and the second ceramic layer have important role in the mechanism of causing cracks and chips.

According to a conventional manufacturing method, the bonding layer forming paste is coated on the first ceramic layer forming green sheet. Then, the first ceramic layer forming green sheet and the second ceramic layer forming green sheet are laminated into a laminated assembly with the bonding layer forming paste intervening between these green sheets. Then, the laminated assembly is sintered into a ceramic laminate. In this case, there is a possibility that an uneven surface remains on the bonding layer forming paste after the bonding layer forming paste is coated on the first ceramic layer forming green sheet. If the bonding layer forming paste having an uneven surface is faced down on the second ceramic layer forming green sheet, a significant amount of air bubbles will remain between the bonding layer and the second ceramic layer after the green sheets are sintered. The residual air bubbles reduce the bonding strength of the bonding layer intervening between the surfaces to be bonded together.

The first ceramic layer of the present invention has gas permeability. The bonding layer forming paste is, usually, made of a viscous material that contains ceramic grains identical or similar in composition with the first and second ceramic layers and mixed with a binder into a paste state. The binder volatilizes through the sintering operation. Accordingly, mutually fused ceramic grains remain after finishing the sintering operation. The bonding layer is thus relatively porous and gas permeable.

It is now assumed that a gas containing water vapor enters into the first ceramic layer. The first ceramic layer is gas permeable, and the bonding layer is relatively gas permeable. Accordingly, the water vapor containing gas passes the first ceramic layer and the bonding layer successively and can reach air bubbles residing between the bonding layer and the second ceramic layer. The second ceramic layer is gas impermeable and therefore the gas settles in the air bubbles. When the ambient temperature of air bubbles decreases, the water vapor contained in the gas condenses into waterdrop. The waterdrop remains in the air bubbles. After that, if the ambient temperature of air bubbles increases, the waterdrop will return to water vapor. The pressure in the air bubbles increases due to thermal expansion. The increased internal pressure of air bubbles forcibly peels the bonding layer off the second ceramic layer. As a result, cracks and chips appear in the vicinity of air bubbles.

To eliminate the cracks and chips resulting from the above reasons, the inventors of this invention have experimentally manufactured a ceramic laminate by first coating the bonding layer forming paste on a surface of the second ceramic layer forming green sheet and then laminating the first ceramic layer forming green sheet on the surface of the bonding layer forming paste into a laminated assembly and finally sintering the laminated assembly. In this case, the bonding layer forming paste may have an uneven surface. However, this uneven surface faces the first ceramic layer forming green sheet. Accordingly, air bubbles reside between the first ceramic layer and the bonding layer of the ceramic laminate manufactured according to the first manufacturing method.

The gas containing water vapor entering from the outside passes the first ceramic layer and reaches the air bubbles and then condenses into waterdrop there. After that, in accordance with increase of the ambient temperature of air bubbles, the waterdrop returns to water vapor. The member located just above the air bubbles is the first ceramic layer having gas permeability. The water vapor smoothly passes the first ceramic layer and goes out of the ceramic body. The internal pressure of air bubbles does not increase.

Accordingly, the first manufacturing method of the present invention can obtain a ceramic laminate which is capable of adequately retaining the internal pressure of the air bubbles and accordingly free from cracks and chips.

Furthermore, the present invention provides a second method for manufacturing a ceramic laminate according to a numerous-pieces-taken method. The ceramic laminate includes a first ceramic layer and a second ceramic layer which are laminated with each other via a bonding layer. The first ceramic layer has gas permeability. The second ceramic layer has gas impermeability. The numerous-pieces-taken method of this invention includes the following first to fifth steps. The first step is forming first and second numerous-pieces-taken base sheets for forming first and second ceramic layers. The second step is disposing the second numerous-pieces-taken base sheet on a lower die. The third step is disposing the first numerous-pieces-taken base sheet on a surface of an upper die, with a bonding layer forming paste coated beforehand on the first numerous-pieces-taken base sheet. The fourth step is pressing the upper die toward the lower die or pressing the lower die toward the upper die to obtain an integrated assembly of the first and second numerous-pieces-taken base sheets which are laminated and bonded together. And, the fifth step of dividing the integrated assembly into separate bodies and then sintering the separate bodies. According to the second manufacturing method of this invention, the surface of the upper die is an acute-angled surface with a central region protruding toward the lower die and right and left slant regions regressing obliquely from the central region to respective edge regions. In a process of integrally laminating and bonding the first and second numerous-pieces-taken base sheets, the acute-angled surface first presses a corresponding center of the second numerous-pieces-taken base sheet at the central region thereof. The acute-angled surface finally presses corresponding right and left edge portions of the second numerous-pieces-taken base sheet at the edge regions thereof, thereby successively pressing and integrating the first and second numerous-pieces-taken base sheets symmetrically from their central regions to respective right and left edge portions

According to the second manufacturing method of the present invention, in the process of integrally laminating and bonding the first and second numerous-pieces-taken base sheets, the first numerous-pieces-taken base sheet is first brought into contact with the second numerous-pieces-taken base sheet at a portion facing to the central region of the acute-angled surface of the upper die. Next, they contact at the neighboring region adjacent to the central region of the acute-angled surface. The contact between the first and second numerous-pieces-taken base sheets is successively delayed in accordance with a distance departing from the central region. Accordingly, even if air bubbles remain in a space intervening between the bonding layer forming paste and the second numerous-pieces-taken base sheet, the residual air bubbles are forcibly pushed out from the formerly pressed region to the later pressed region. According to the second manufacturing method of the present invention, the successive pressing operation advances symmetrically from the central region to the right and left edge portions of the acute-angled surface of the upper die. The air bubbles residing in the central region are successively pushed out toward respective right and left edge portions. As a result, the process of integrally laminating and bonding the first and second numerous-pieces-taken base sheets can be accomplished without leaving any air bubbles between them.

Accordingly, the second manufacturing method of the present invention can provide a ceramic laminate containing substantially no air bubbles which increase the internal pressure of the bonding layer. Accordingly, the second manufacturing method of the present invention can obtain a ceramic laminate which is capable of adequately retaining the internal pressure of the air bubbles and accordingly free from cracks and chips.

Furthermore, the present invention provides a third method for manufacturing a ceramic laminate including a first ceramic layer and a second ceramic layer which are laminated with each other via a bonding layer. The first ceramic layer has gas permeability. The second ceramic layer has gas impermeability. The third manufacturing method of this invention includes the following first to fifth steps. The first step is forming first and second ceramic layer forming green sheets. The second step is coating a bonding layer forming paste on the first ceramic layer forming green sheet. The third step is placing the first ceramic layer forming green sheet on the second ceramic layer forming green sheet. The fourth step is integrally laminating and bonding the first and second ceramic layer forming green sheets by successively pressing the first and second ceramic layer forming green sheets in a single direction from one end region to the other end region. And, the fifth step is sintering a laminated body including the first and second ceramic layer forming green sheets.

According to the third manufacturing method of the present invention, the first and second ceramic layer forming green sheets are successively laminated and bonded in a single direction from one end region to the other end region so that the residual air bubbles are forcibly pushed from the formerly pressed region to the later pressed region. As a result, the first ceramic layer forming green sheet is integrally laminated and bonded with the bonding layer and the second ceramic layer forming green sheet without leaving any air bubbles between them.

Accordingly, the third manufacturing method of the present invention can provide a ceramic laminate containing substantially no air bubbles which increase the internal pressure of the bonding layer. Accordingly, the third manufacturing method of the present invention can obtain a ceramic laminate which is capable of adequately retaining the internal pressure of the air bubbles and accordingly free from cracks and chips.

Furthermore, the present invention provides a fourth method for manufacturing a ceramic laminate including a first ceramic layer and a second ceramic layer which are laminated with each other via a bonding layer. The first ceramic layer has gas permeability. The second ceramic layer has gas impermeability. The fourth manufacturing method of this invention includes the following first to fourth steps. The first step is forming first and second ceramic layer forming green sheets. The second step is coating a bonding layer forming paste on the first ceramic layer forming green sheet by a thickness of 5 to 150 μm. The third step is integrally laminating and bonding the second ceramic layer forming green sheet on the bonding layer forming paste. And, the fourth step is sintering a laminated body including the first and second ceramic layer forming green sheets.

As described above, the air bubbles reside in the bonding layer after finishing the sintering operation of the laminated assembly due to the uneven surface of the bonding layer forming paste.

According to the fourth manufacturing method of the present invention, the bonding layer forming paste has a sufficient coating thickness to eliminate undulations formed on the surface of the first ceramic layer forming green sheet including the bonding layer forming paste. This effectively suppresses the amount of air bubbles residing between the bonding layer forming paste and the second ceramic layer forming green sheet.

Accordingly, the fourth manufacturing method of the present invention can provide a ceramic laminate containing substantially no air bubbles which increase the internal pressure of the bonding layer. Accordingly, the fourth manufacturing method of the present invention can obtain a ceramic laminate which is capable of adequately retaining the internal pressure of the air bubbles and accordingly free from cracks and chips.

The effects of the present invention will not be obtained when the thickness of the bonding layer forming paste is less than 5 μm. On the other hand, when the thickness of the bonding layer forming paste is larger than 150 μm, the sheets integrally assembled with an adhesive into a laminate will cause positional dislocation when this laminate is cut into separate pieces by a cutter.

Furthermore, the present invention provides a fifth method for manufacturing a ceramic laminate including a first ceramic layer and a second ceramic layer which are laminated with each other via a bonding layer. The first ceramic layer has gas permeability. The second ceramic layer has gas impermeability. The fifth manufacturing method of this invention includes a step of providing a shielding layer between the first ceramic layer and the bonding layer. The shielding layer has the porosity lower than that of the first ceramic layer.

As described above, the water vapor containing gas enters into the air bubbles. The water vapor condenses into waterdrop in the air bubbles. This waterdrop is the main cause of cracks and chips. The fifth manufacturing method of the present invention provides the shielding layer between the bonding layer and the first ceramic layer having gas permeability. The shielding layer prevents the water vapor from entering into the air bubbles. Accordingly, the fifth manufacturing method of the present invention can obtain a ceramic laminate which is capable of adequately retaining the internal pressure of the air bubbles and accordingly free from cracks and chips.

The present invention provides a sixth method for manufacturing a ceramic laminate including a first ceramic layer and a second ceramic layer which are laminated with each other via a bonding layer. The first ceramic layer has gas permeability. The second ceramic layer has gas impermeability. The sixth manufacturing method of this invention includes the following first to fifth steps. The first step is forming first and second ceramic layer forming green sheets. The second step is disposing the second ceramic layer forming green sheet on a lower die. The third step is disposing the first ceramic layer forming green sheet on an upper die with a bonding layer forming paste coated beforehand on the first ceramic layer forming green sheet. The fourth step is pressing the upper die toward the lower die or pressing the lower die toward the upper die to obtain an integrated assembly of the first and second ceramic layer forming green sheets which are laminated and bonded together, while oscillating a diaphragm disposed on the upper die or the lower die. And, the fifth step is sintering the integrated assembly of the first and second ceramic layer forming green sheets.

As described above, the air bubbles reside in the bonding layer after finishing the sintering operation of the laminated assembly due to the uneven surface of the bonding layer forming paste. The sixth manufacturing method of the present invention oscillates the upper or lower die on which the first ceramic layer forming green sheet is disposed with the bonding layer forming paste coated thereon. This is effective in flattening the surface of the bonding layer forming paste. Accordingly, it becomes possible to decrease the amount of air bubbles residing between the bonding layer forming paste and the second ceramic layer forming green sheet.

Accordingly, the sixth manufacturing method of the present invention can manufacture a ceramic laminate containing substantially no air bubbles which increase the internal pressure of the bonding layer. Accordingly, the sixth manufacturing method of the present invention can obtain a ceramic laminate which is capable of adequately retaining the internal pressure of the air bubbles and accordingly free from cracks and chips.

Furthermore, the present invention provides a ceramic laminate including a first ceramic layer and a second ceramic layer which are laminated with each other via a bonding layer. The first ceramic layer has gas permeability. The second ceramic layer has gas impermeability. According to the ceramic laminate of this invention, no air bubbles reside along a boundary between the bonding layer and the second ceramic layer. Air bubbles reside along a boundary between the bonding layer and the first ceramic layer.

According to this arrangement, it becomes possible to obtain a ceramic laminate causing substantially no cracks and chips and therefore having excellent durability.

As described above, there is the possibility that air bubbles remain between the layers to be bonded in the manufacturing process of a ceramic laminate. When the air bubbles settle along the boundary between the bonding layer and the second ceramic layer, cracks and chips appear in the vicinity of the residual air bubbles.

However, according to the ceramic laminate of this invention, no air bubbles reside in the boundary between the bonding layer and the second ceramic layer. The air bubbles reside along the boundary between the bonding layer and the first ceramic layer. The first ceramic layer has gas permeability.

Therefore, even if the waterdrop in the air bubbles returns to water vapor, the water vapor can smoothly pass the first ceramic layer and go out of the ceramic body. The internal pressure of air bubbles does not increase.

Accordingly, the present invention provides a ceramic laminate that causes substantially no cracks and chips and accordingly can assure excellent durability.

Moreover, the present invention provides a multilayered gas sensing element for detecting the concentration of a specific gas in a measured gas. The multilayered gas sensing element includes a ceramic laminate including a first ceramic layer and a second ceramic layer which are laminated with each other via a bonding layer. The first ceramic layer has gas permeability. The second ceramic layer has gas impermeability. No air bubbles reside along a boundary between the bonding layer and the second ceramic layer. Air bubbles are present along a boundary between the bonding layer and the first ceramic layer.

Accordingly, the present invention provides a multilayered gas sensing element that causes substantially no cracks and chips and accordingly can assure excellent durability.

### BRIEF DESCRIPTION OF THE DRAWINGS

The above and other objects, features and advantages of the present invention will become more apparent from the following detailed description which is to be read in conjunction with the accompanying drawings, in which:

FIG. 1 is a plan view showing a multilayered gas sensing element;

FIG. 2 is a cross-sectional view showing the multilayered gas sensing element taken along a line A-A of FIG. 1;

FIGS. 3A to 3E are views explaining sequential processes for manufacturing a multilayered gas sensing element in accordance with a first embodiment of the present invention;

FIG. 4 is a cross-sectional view explaining the condition of an air bubble residing in a bonding layer of the multilayered gas sensing element formed according to the manufacturing processes shown in FIGS. 3A to 3E;

FIGS. 5A to 5E are views explaining sequential processes for manufacturing a multilayered gas sensing element in accordance with a conventional method;

FIG. 6 is a cross-sectional view explaining the condition of an air bubble residing in a bonding layer of the multilayered gas sensing element formed according to the manufacturing processes shown in FIGS. 5A to 5E;

FIG. 7 is a plan view showing an assembled unit including first and second numerous-pieces-taken base sheets integrally laminated and bonded in accordance with a second embodiment of the present invention;

FIGS. 8A to 8E are views explaining sequential processes for integrally laminating and bonding base sheets placed between upper and lower dies in accordance with the second embodiment of the present invention;

FIGS. 9A to 9D are views explaining the conditions of a bonding layer forming paste and the second numerous-pieces-taken base sheet during a pressing operation in accordance with the second embodiment of the present invention;

FIG. 10 is a perspective view showing an upper die having an acute-angled elastic member in accordance with the second embodiment of the present invention;

FIG. 11 is a view showing the upper and lower dies in accordance with the second embodiment of the present invention;

FIG. 12 is a perspective view showing one example of the acute-angled elastic member in accordance with the second embodiment of the present invention;

FIG. 13 is a perspective view showing another example of the acute-angled elastic member in accordance with the second embodiment of the present invention;

FIG. 14 is a perspective view showing another example of the acute-angled elastic member in accordance with the second embodiment of the present invention;

FIG. 15 is a perspective view showing another example of the acute-angled elastic member in accordance with the second embodiment of the present invention;

FIG. 16 is a perspective view showing a conventional upper die having a flat elastic member;

FIGS. 17A and 17B are views explaining a process for bonding first and second numerous-pieces-taken base sheets via a thick bonding layer forming paste in accordance with a third embodiment of the present invention;

FIGS. 18A and 18B are views explaining a process for bonding first and second numerous-pieces-taken base sheets via a relatively thin bonding layer forming paste in accordance with a conventional manufacturing method;

FIG. 19 is a graph showing the total length of air bubbles residing in a multilayered gas sensing element manufactured according to the method of the first embodiment of the present invention;

FIG. 20 is a graph showing the residual platinum concentration in the multilayered gas sensing element manufactured according to the method of the first embodiment of the present invention;

FIG. 21 is a graph showing the total length of air bubbles residing in a multilayered gas sensing element manufactured according to the method of the second embodiment of the present invention;

FIG. 22 is a graph showing the residual platinum concentration in the multilayered gas sensing element manufactured according to the method of the second embodiment of the present invention;

FIG. 23 is a graph showing the total length of air bubbles residing in a multilayered gas sensing element manufactured according to the method of the third embodiment of the present invention;

FIG. 24 is a graph showing the residual platinum concentration in the multilayered gas sensing element manufactured according to the method of the third embodiment of the present invention;

FIG. 25 is a graph showing the total length of air bubbles residing in a multilayered gas sensing element manufactured according to a conventional method;

FIG. 26 is a graph showing the residual platinum concentration in the multilayered gas sensing element manufactured according to the conventional method;

FIG. 27 is a graph showing the result of a water absorption debugging test;

FIG. 28 is a graph showing the result of a vacuum/water absorption debugging test;

FIG. 29 is a graph showing the relationship between air bubble length and residual platinum concentration measured in a multilayered gas sensing element having a shielding layer manufactured in accordance with a fourth embodiment of the present invention;

FIG. 30 is a graph showing the relationship between air bubble length and residual platinum concentration measured in a multilayered gas sensing element manufactured according to a conventional method;

FIG. 31 is a view explaining cutting lines being set for evaluating a multilayered gas sensing element manufactured according to the fourth embodiment of the present invention;

FIG. 32 is a graph showing the number of air bubbles in a multilayered gas sensing element manufactured in accordance with a fifth embodiment of the present invention;

FIG. 33 is a graph showing the size of air bubbles residing in the multilayered gas sensing element manufactured in accordance with the fifth embodiment of the present invention; and

FIG. 34 is a cross-sectional view similar to FIG. 2 but showing the multilayered gas sensing element manufactured in accordance with the fourth embodiment of the present invention.

### DESCRIPTION OF THE PREFERRED EMBODIMENTS

Preferred embodiments of the present invention will be explained hereinafter with reference to attached drawings.

The ceramic laminate manufactured in accordance with the present invention includes a first ceramic laminate which is gas permeable, i.e. porous, to allow a water vapor containing gas to penetrate and a second ceramic laminate which is gas impermeable, i.e. dense, to prevent the water vapor containing gas from going out of the ceramic body. The first ceramic laminate and the second ceramic laminate are integrated with a bonding layer. A bonding layer forming paste, later becoming the bonding layer through the sintering operation, is made of a viscous material that contains ceramic grains identical or similar in composition with the first and second ceramic layers and mixed with a binder into a paste state. The binder volatilizes through the sintering operation. Accordingly, mutually fused ceramic grains remain after finishing the sintering operation. The bonding layer is thus relatively porous and gas permeable.

According to the ceramic laminate having the above-described arrangement, water vapor condenses into waterdrop in air bubbles residing in the bonding layer. The internal pressure of air bubbles increases when the ambient temperature is high. A thermal stress will increase in the vicinity of the air bubbles and cause cracks and chips.

The manufacturing method of the present invention can be applied to various products including ceramic laminates so that manufactured products can possess excellent durability and also have long life time.

The exhaust system of various automotive engines is generally equipped with a multilayered gas sensing element consisting of ceramic layers laminated together. The gas sensing element has a role of measuring the concentration of various gas component contained in the exhaust gas. Alternatively, the gas sensing element has a role of measuring the air-fuel ratio in a combustion chamber of the engine to control combustion of the engine based on the measured air-fuel ratio.

The exhaust gas contains high-temperature water vapor. When the engine is operating (i.e. when an automotive vehicle is traveling), a multilayered gas sensing element is subjected to high temperatures of 700° C. to 900° C. When the engine is stopped (i.e. when an automotive vehicle is stopped), the multilayered gas sensing element is cooled down to low temperatures of −20° C. to 40° C. similar to the ambient temperatures. The multilayered gas sensing element, although can be formed into various configurations, generally includes a first ceramic layer having gas permeability and a second ceramic layer having gas impermeability which are integrated via a bonding layer intervening between these layers. The multilayered gas sensing element including these ceramic layers is installed in an exhaust system of an automotive engine. If the internal pressure of residual air bubbles increases in the bonding layer, cracks and chips will be caused.

According to the manufacturing method of the present invention, it is possible to manufacture a multilayered gas sensing element which is used in an exhaust system of an automotive engine and is free from cracks and chips and excellent in durability.

Regarding a practical arrangement of the multilayered gas sensing element, the first ceramic layer can serve as a diffusion resistance layer having a function of determining a diffusion rate of the exhaust gas (i.e. measured gas) introduced into a measured gas chamber. The second ceramic layer can serve as a dense spacer defining the measured gas chamber.

Furthermore, the multilayered gas sensing element can be arranged in various ways. For example, it is possible to laminate a gas permeable layer and a gas impermeable layer via another layer (e.g. a bonding layer) having relatively low gas permeability. In this case, the manufacturing method of the present invention can effectively suppress generation of any cracks and chips. The manufacturing method of the present invention can be applied to a manufacturing method using numerous-pieces-taken base sheets.

Furthermore, when a shielding layer is provided between the first ceramic layer and the bonding layer, it is preferable that the porosity of the shielding layer is equal to or less than 2%.

If the porosity is excessively high, the water vapor containing gas will easily pass the shielding layer. The effects of the present invention will not be obtained. An ideal shielding layer has the porosity of zero.

Furthermore, when a multilayered gas sensing element is used for detecting the concentration of a specific gas contained in a measured gas, it is desirable that the multilayered gas sensing element is manufactured according to the ceramic laminate manufacturing method of the present invention. A manufactured multilayered gas sensing element is free from cracks and chips and excellent in durability.

Furthermore, according to the ceramic laminate of the present invention, it is preferable that the air bubbles reside in a space defined between a recess of a surface of the bonding layer and the first ceramic layer. The ceramic laminate can be easily manufactured.

More specifically, in manufacturing the ceramic laminate, it is for example preferable to coat a bonding layer forming paste on a second ceramic layer forming green sheet. Then, the first ceramic layer forming green sheet is integrally laminated and bonded on the bonding layer forming paste. In this case, an uneven surface remains on the bonding layer forming paste coated on the second ceramic layer forming green sheet. The air bubbles reside in a space formed between the recess of the uneven surface and the first ceramic layer. According to this arrangement, the ceramic laminate can be easily manufactured.

### First Embodiment

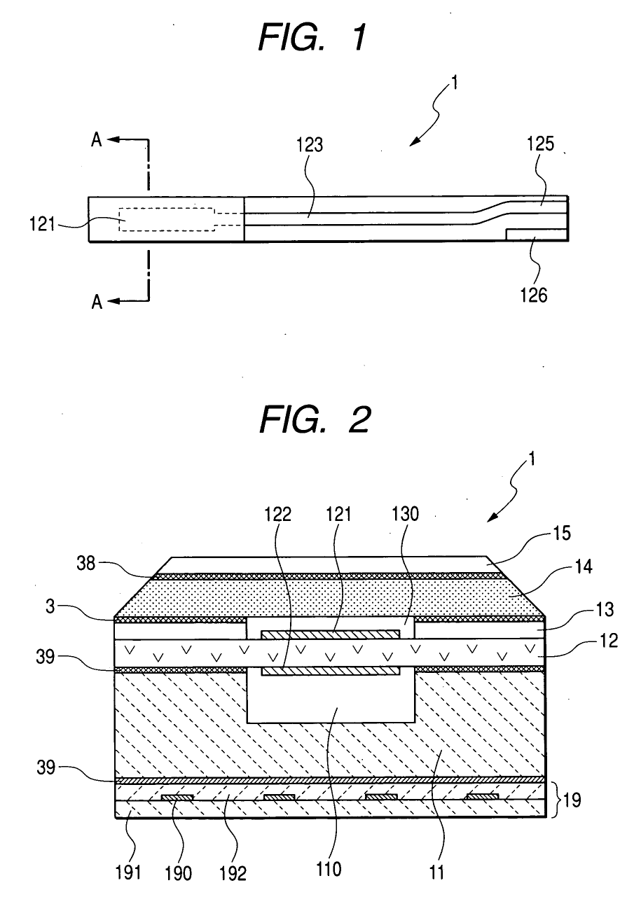

FIGS. 1 to 6 explain a multilayered gas sensing element containing a ceramic laminate in accordance with a manufacturing method of a first embodiment of the present invention.

A ceramic laminate of this embodiment includes a first ceramic layer having gas permeability and a second ceramic layer having gas impermeability that are laminated with each other via a bonding layer.

In manufacturing this ceramic laminate, first and second ceramic layer forming green sheets are formed. A bonding layer forming paste is coated on a surface of the second ceramic layer forming green sheet. The first ceramic layer forming green sheet is laminated on a surface of the bonding layer forming paste to obtain an assembled body. Then, this assembled body is sintered.

This manufacturing method is utilized for manufacturing a multilayered gas sensing element 1 shown in FIGS. 1 and 2.

The manufacturing method of this embodiment is for forming a multilayered gas sensing element 1 including a ceramic laminate. The multilayered gas sensing element 1, which is installed in an exhaust gas system for an automotive engine, detects an air-fuel ratio of an engine combustion chamber based on the oxygen concentration in an exhaust gas emitted from the engine.

As shown in FIGS. 1 and 2, the multilayered gas sensing element 1 of this embodiment includes a heater 19, a spacer 11, a solid electrolyte layer 12, a spacer 13, a diffusion resistance layer 14, and a dense layer 15 that are successively laminated in this order. The heater 19 includes two ceramic layers 191 and 192 and a heat-generating element 190 sandwiched between these ceramic layers. The heat-generating element 190 generates heat in response to supplied electric power. The spacer 11 defines a reference gas chamber 110 storing the air serving as a reference gas. The spacer 13 defines a measured gas chamber 130 storing the exhaust gas. The exhaust gas is introduced into the measured gas chamber 130 via the diffusion resistance layer 14. The diffusion resistance layer 14 has a function of determining a diffusion rate of the exhaust gas. The dense layer 15 regulates the flowing direction of the exhaust gas introduced into the diffusion resistance layer 14.

As shown in FIG. 2, the solid electrolyte layer 12 has one surface on which a reference electrode 122 is formed and the other surface on which a measured gas side electrode 121 is formed. The reference electrode 122 is positioned in the reference gas chamber 110. The measured gas side electrode 121 is in the measured gas chamber 130. Two electrodes 121, 122 and the solid electrolyte layer 12 cooperatively constitute a sensing cell for detecting the oxygen concentration.

Furthermore, the measured gas chamber defining spacer 13 extends in the longitudinal direction (refer to FIG. 1) of the multilayered gas sensing element 1. The diffusion resistance layer 14 and the dense layer 15 are identical in size with the measured gas chamber defining spacer 13.

The solid electrolyte layer 12 has a portion exposed to the outside. Two terminals 125 and 126, provided on this exposed portion, are electrically conductive with the reference electrode 121 and the measured gas side electrode 122, respectively. A lead portion 123 connects the electrode 121 and the terminal 125. Another lead portion (not shown) connects the electrode 122 and the terminals 126.

The measured gas chamber defining spacer 13 is made of a dense alumina ceramic having the gas impermeability (having the porosity of 2% or less). The measured gas chamber defining spacer 13 prevents excessive exhaust gas from entering into the measured gas chamber 130 from a side surface. The solid electrolyte layer 12 is made of a dense zirconia ceramic having the oxygen conductivity (having the porosity of 2% or less). The dense layer 15 is made of a dense alumina ceramic.

The diffusion resistance layer 14 is made of a gas permeable alumina ceramic having a higher porosity (e.g. porosity 15%). The exhaust gas is introduced into the measured gas chamber 130 via the diffusion resistance layer 14. The diffusion resistance layer 14 is the first ceramic layer having gas permeability. The measured gas chamber defining spacer 13 is the second ceramic layer having gas impermeability.

Furthermore, the heater 19 is connected with the reference gas chamber defining spacer 11 via a bonding layer 39. The reference gas chamber defining spacer 11 is connected with the solid electrolyte layer 12 via another bonding layer 39. The measured gas chamber defining spacer 13 is connected with the diffusion resistance layer 14 via a bonding layer 3. In forming the bonding layer 3, alumina grains identical in composition with the diffusion resistance layer 14 are mixed with an acryl resin binder into a viscous material of paste state. This paste is then sintered. The bonding layer 3 is thus constituted by an alumina ceramic having the porosity of approximately 2% and is accordingly relatively gas permeable.

The multilayered gas sensing element 1 is manufactured in the following manner.

A green sheet is prepared for forming the ceramic layer 191. An electrode paste is prepared for the heat-generating element 190. The heat-generating element forming electrode paste is coated on the ceramic layer forming green sheet. A paste is formed for forming the ceramic layer 192. The ceramic layer forming paste is printed upside down on the surface of the ceramic layer forming green sheet.

Meanwhile, an unbaked ceramic with a groove (becoming a spacer for defining a reference gas chamber 11 through the sintering operation) is prepared. A paste is prepared for forming the bonding layer 39. The bonding layer forming paste is coated on the lower surface of the unbaked ceramic. The unbaked ceramic integrated with the bonding layer forming paste is then laminated on the upper surface of an assembled body consisting of unbaked ceramic layers 191 and 192 with the heat-generating element 190 sandwiched therebetween.

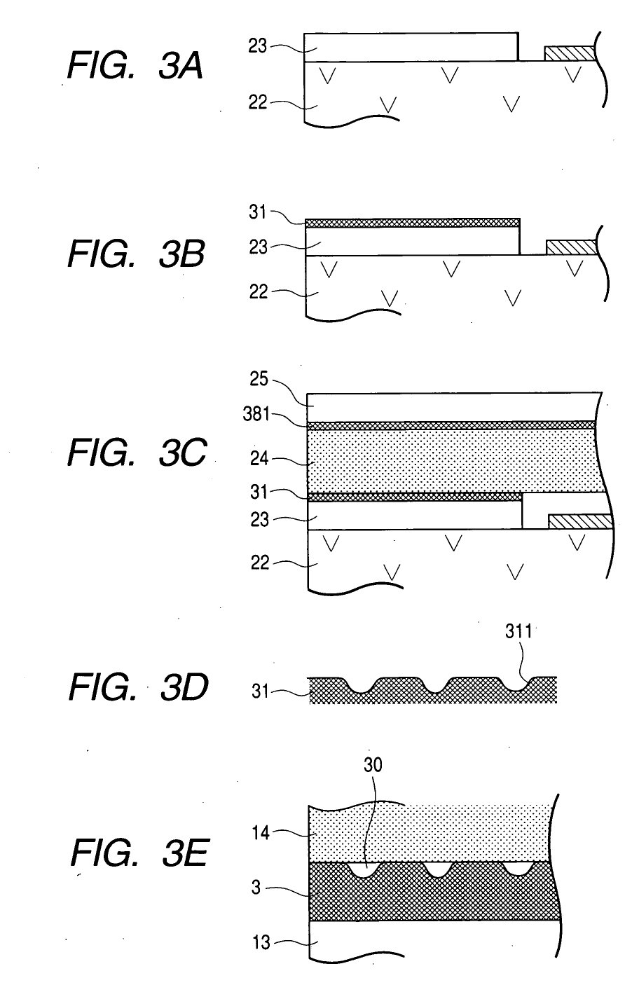

Furthermore, a green sheet 22 is prepared for forming the solid electrolyte layer 12 (refer to FIGS. 3A-3C). A paste is prepared for forming the bonding layer 39. The bonding layer forming paste is coated on the lower surface of the solid electrolyte layer green sheet 22. An electrode paste is coated beforehand as a predetermined pattern of print portions on the solid electrolyte layer forming green sheet 22. The print portions later become the electrodes 121, 122, the lead portion 123, and the terminals 125, 126 through the sintering operation.

Meanwhile, a green sheet 23 is prepared for forming the measured gas chamber defining spacer 13. A paste 31 is prepared for forming the bonding layer 3. A green sheet 24 is prepared for forming the diffusion resistance layer 14. A green sheet 25 is prepared for forming the dense layer 15. A paste 381 is prepared for forming a bonding layer 38.

As shown in FIG. 3A, this green sheet 23 is laminated on the solid electrolyte layer forming green sheet 22. Then, as shown in FIG. 3B, the bonding layer forming paste 31 is coated on the green sheet 23 by a thickness of 35 μm. As shown in FIG. 3C, the diffusion resistance layer forming green sheet 24 is laminated on the bonding layer forming paste 31. Then, the dense layer forming green sheet 25 is laminated on the diffusion resistance layer forming green sheet 24 via the bonding layer forming paste 381. An unbaked laminate consisting of multilayered layers having been assembled as described above is then sintered into the multilayered gas sensing element 1 of this embodiment.

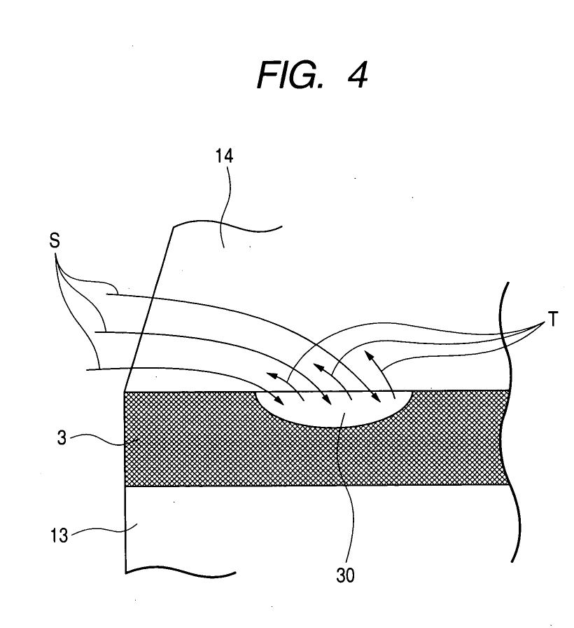

FIG. 3D shows a surface 311 of the bonding layer forming paste 31 which is coated on the green sheet 23 according to the manufacturing method of this embodiment. The surface 311 of the bonding layer forming paste 31 is an uneven surface. The diffusion resistance layer forming green sheet 24 is laminated on the uneven surface 311 of bonding layer forming paste 31. Due to the uneven surface 311, air bubbles 30 reside along the boundary between the diffusion resistance layer 14 and the bonding layer 3, as shown in FIGS. 3E and 4. The air bubbles 30, residing next to the diffusion resistance layer 14 and are accordingly exposed to the diffusion resistance layer 14, trap a gas entering from the diffusion resistance layer 14. Furthermore, the gas residing in the air bubbles 30 can freely move into the diffusion resistance layer 14, as indicated by arrow lines S and T in FIG. 4.

According to conventional manufacturing method, the bonding layer paste 31 is coated on the diffusion resistance layer forming green sheet 24 in the following manner.

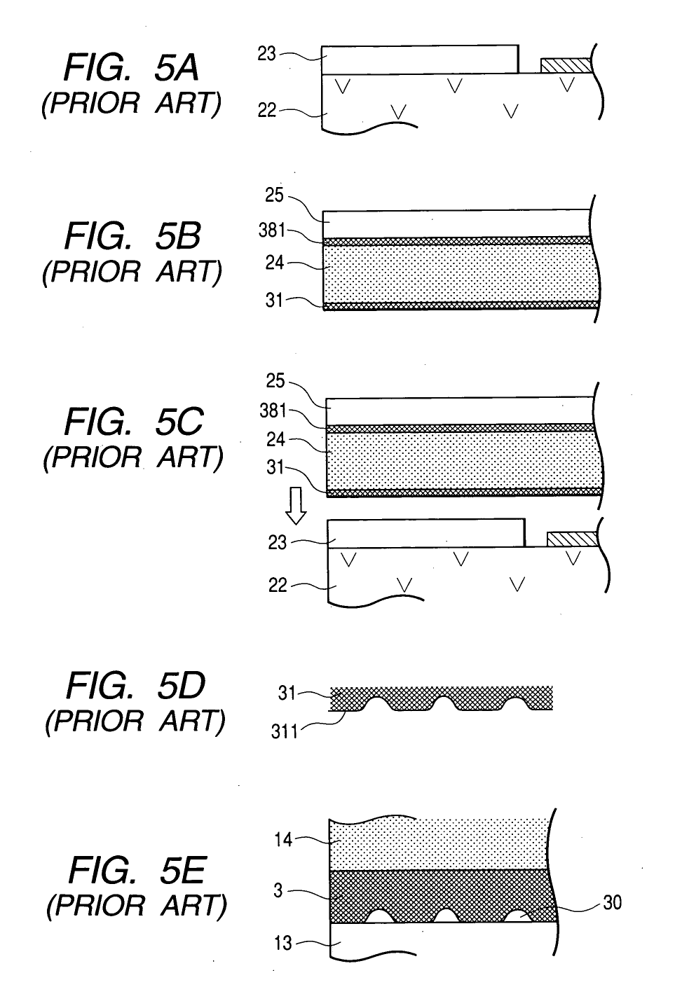

As shown in FIG. 5A, the green sheet 23 for forming the measured gas chamber defining spacer 13 is laminated on the solid electrolyte layer green sheet 22. The conventional manufacturing steps required for realizing the condition shown in FIG. 5 are substantially the same as the above-described manufacturing steps of this embodiment. As shown in FIG. 5B, the diffusion resistance layer forming green sheet 24 is laminated with the dense layer forming green sheet 25. The bonding layer forming paste 31 is coated on the lower surface of the diffusion resistance layer forming green sheet 24. Then, as shown in FIG. 5C, the assembled body is laminated on the green sheet 23 that becomes the measured gas chamber defining spacer 13. In this case, as shown in FIG. 5D, the bonding layer forming paste 31 has the uneven surface 311.

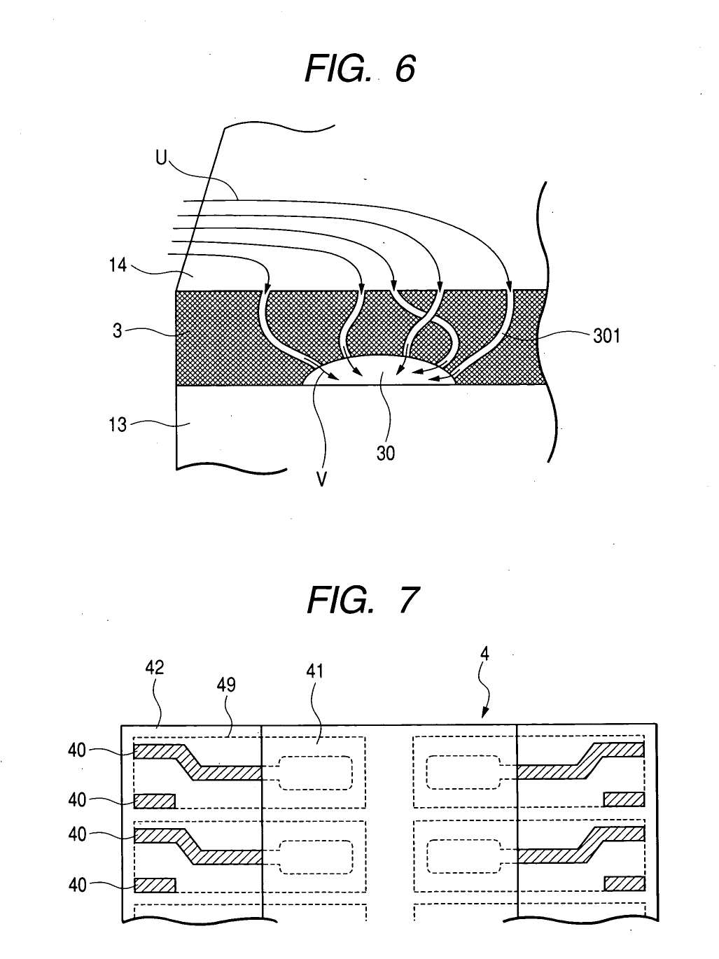

The green sheet 23, becoming the measured gas chamber defining spacer 13, is laminated on the uneven surface 311 of bonding layer forming paste 31 and integrated into a laminate. Then, this laminate is sintered. Due to the uneven surface 311, air bubbles 30 reside along the boundary between the bonding layer 3 and the measured gas chamber defining spacer 13, as shown in FIGS. 5E and 6. The bonding layer 3 is porous as shown in FIG. 6. Accordingly, the bonding layer 3 provides a labyrinth structure 301 which connects the air bubbles 30 and the diffusion resistance layer 14. The labyrinth structure 301 allows the gas entering from the outside to reach the air bubbles 30 as indicated by arrow lines U and V. However, the labyrinth structure 301 restricts the movement of gas. The gas having been once trapped in the air bubbles 30 cannot be smoothly exchanged. The inventors of this invention have confirmed the air bubbles 30 by observing a cut surface of the multilayered gas sensing element 1 with an electron microscope.

The above-described embodiment of the present invention has the following functions and effects.

The multilayered gas sensing element 1 according to this embodiment includes the diffusion resistance layer 14 having gas permeability and the measured gas chamber defining spacer 13 having gas impermeability which are laminated with each other via the bonding layer 3. According to the manufacturing method of the multilayered gas sensing element 1, the bonding layer forming paste 31 is coated on the surface of the green sheet 23 that later becomes the measured gas chamber defining spacer 13. The green sheet 24, later becoming the diffusion resistance layer 14, is laminated on the surface of the bonding layer forming paste 31 (refer to FIGS. 3A to 3C). According to the multilayered gas sensing element 1 of this embodiment, as shown in FIG. 4, the air bubbles 30 reside along the boundary between the diffusion resistance layer 14 and the bonding layer 3. The air bubbles 30 reside next to the diffusion resistance layer 14 and are accordingly exposed to the diffusion resistance layer 14.

On the other hand, according to the conventional manufacturing method, the bonding layer forming paste 31 is coated on the surface of the green sheet 24 that later becomes the diffusion resistance layer 14, as shown in FIG. 5B. According to the conventional manufacturing method, the air bubbles 30 reside along the boundary between the bonding layer 3 and the measured gas chamber defining spacer 13 as shown in FIG. 6. The labyrinth structure 301 provided in the bonding layer 3 allows the exchange of gases between the air bubbles 30 and the diffusion resistance layer 14.

The multilayered gas sensing element 1 of this embodiment is installed in an exhaust system of an automotive engine. The exhaust gas containing water vapor enters into the measured gas chamber 130 via the diffusion resistance layer 14.

When the multilayered gas sensing element 1 is manufactured according to the conventional manufacturing method, the measured gas chamber defining spacer 13 is gas impermeable. Accordingly, as shown in FIG. 6, the exhaust gas is stored in the air bubbles 30. The temperature of the multilayered gas sensing element 1 decreases when the automotive engine is stopped. The water vapor contained in the exhaust gas condenses into waterdrop in the air bubbles 30. The temperature of the multilayered gas sensing element 1 increases when the automotive engine starts operation again. The waterdrop returns to water vapor. The internal pressure of the air bubbles 30 increases due to thermal expansion. The increased internal pressure of the air bubbles 30 forces the measured gas chamber defining spacer 13 and the bonding layer 3 to peel from each other. As a result, cracks and chips appear in the vicinity of the air bubbles 30.

When the multilayered gas sensing element 1 is manufactured according to this embodiment, the air bubbles 30 reside next to the diffusion resistance layer 14 and are accordingly exposed to the diffusion resistance layer 14 as shown in FIG. 4. The exhaust gas is trapped in the air bubbles 30. However, when the waterdrop volatilizes and expands, the water vapor can promptly go out of the element body via the diffusion resistance layer 14. The internal pressure of the air bubbles 30 does not increase. Accordingly, this embodiment provides the manufacturing method for a multilayered gas sensing element which is capable of adequately retaining the internal pressure of the air bubbles and accordingly free from cracks and chips.

As apparent from the foregoing description, this embodiment provides a first method for manufacturing a ceramic laminate including a first ceramic layer and a second ceramic layer which are laminated with each other via a bonding layer. The first ceramic layer has gas permeability. The second ceramic layer has gas impermeability. The first manufacturing method includes a first step of forming first and second ceramic layer forming green sheets, a second step of coating a bonding layer forming paste on the second ceramic layer forming green sheet, and a third step of integrally bonding the first ceramic layer forming green sheet with the bonding layer forming paste into a laminated body and then sintering the laminated body.

### Second Embodiment

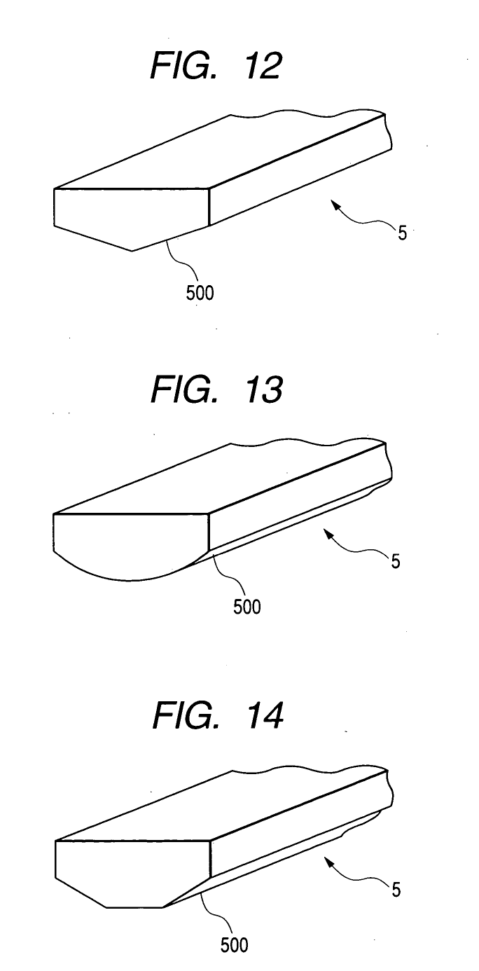

The second embodiment relates to a method for manufacturing a multilayered gas sensing element including a diffusion resistance layer serving as a first ceramic layer having gas permeability and a measured gas chamber defining spacer serving as a second ceramic layer having gas impermeability which are laminated with each other via a bonding layer. The second embodiment proposes a method for manufacturing a plurality of multilayered gas sensing elements from a large numerous-pieces-taken base sheet as shown in FIGS. 7 to 17.

The manufacturing method of the second embodiment includes the following steps:
(1) forming a first numerous-pieces-taken base sheet and a second numerous-pieces-taken base sheet;
(2) preparing a lower die on which the second numerous-pieces-taken base sheet is disposed;
(3) preparing an upper die having a surface on which the first numerous-pieces-taken base sheet with a bonding layer forming paste coated thereon is disposed;
(4) pressing the upper die toward the lower die, so that the first and second numerous-pieces-taken base sheets are integrally laminated and bonded into an integrated assembly; and
(5) dividing the integrated assembly into separate bodies and then sintering the separate bodies, thereby obtaining a plurality of multilayered gas sensing elements at a time.

The step of dividing the integrated assembly into separate bodies can be performed after the sintering step.

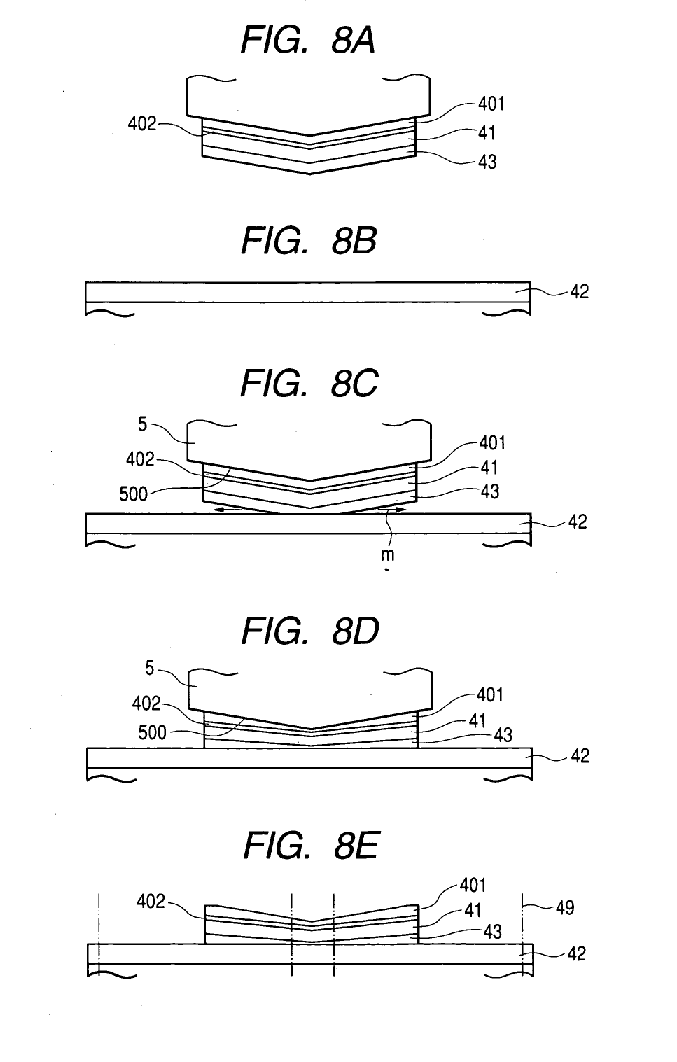

The upper die used according to the manufacturing method of the second embodiment has a die surface on which the first numerous-pieces-taken base sheet is disposed. The die surface of the upper die is an acute-angled surface with a central region protruding toward the lower die and right and left slant regions regressing obliquely from the central region to respective edge regions as shown in FIGS. 8A to 8E.

Accordingly, as shown in FIGS. 8A to 8E, in a process of integrally laminating and bonding the first and second numerous-pieces-taken base sheets, the acute-angled surface first presses a corresponding center of the second numerous-pieces-taken base sheet at the central region thereof. The acute-angled surface finally presses corresponding right and left edge portions of the second numerous-pieces-taken base sheet at edge regions thereof. Thus, the operation for pressing and integrating the first and second numerous-pieces-taken base sheets is successively performed symmetrically from their central regions to respective right and left edge portions.

More specifically, this embodiment provides a method for manufacturing a multilayered gas sensing element similar in arrangement to that of the first embodiment. A predetermined number of large numerous-pieces-taken base sheets are prepared and laminated into an assembled unit 4 as shown in FIG. 7. The assembled unit 4 is sintered and then divided into separate pieces along a broken line with a cutter to obtain numerous multilayered gas sensing elements. This method is advantageous in that numerous multilayered gas sensing elements can be manufactured at a time and is preferably applicable to a mass production of the same products.

FIG. 7 is a plan view showing the assembled unit 4, wherein a reference numeral 41 represents a first numerous-pieces-taken base sheet. The first numerous-pieces-taken base sheet 41 is positioned beneath a dense layer forming base sheet when seen from the above as shown in FIG. 7. A reference numeral 42 represents a second numerous-pieces-taken base sheet. Similar base sheets, forming a solid electrolyte layer and other layers, are laminated beneath the second numerous-pieces-taken base sheet 42. A reference numeral 40 represents print portions that later become electrodes, lead portions, and terminals through the sintering operation. A reference numeral 49 represents a cutting line along which the laminated base sheets are cut into numerous pieces.

Furthermore, although not shown in FIG. 7, a bonding layer forming paste 43 intervenes between the first numerous-pieces-taken base sheet 41 and the second numerous-pieces-taken base sheet 42.

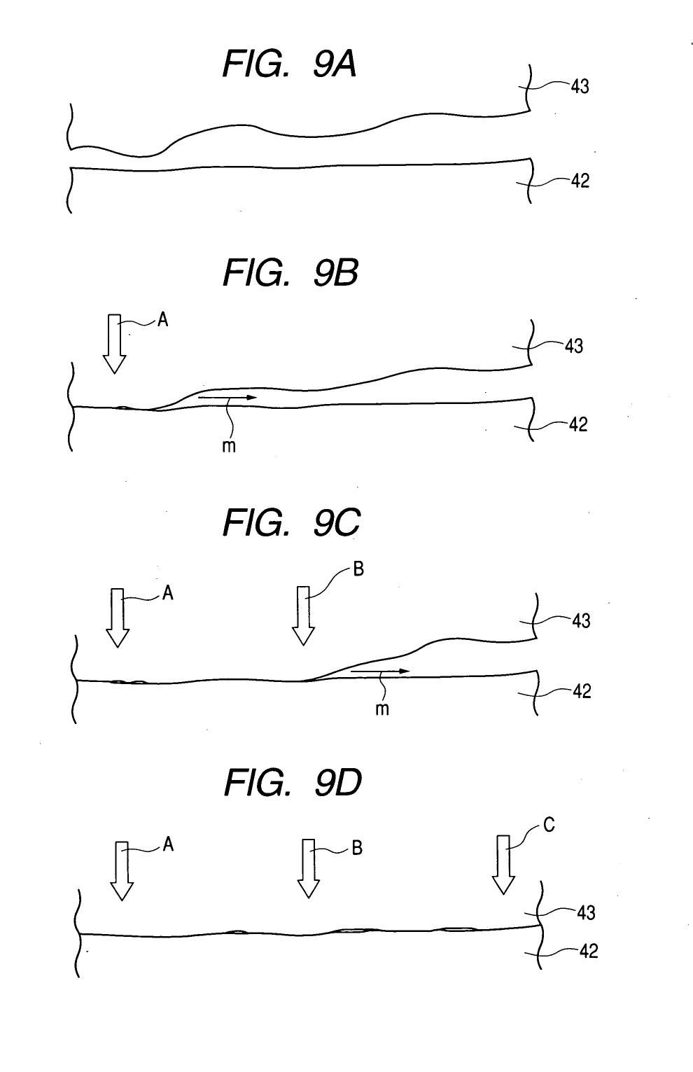

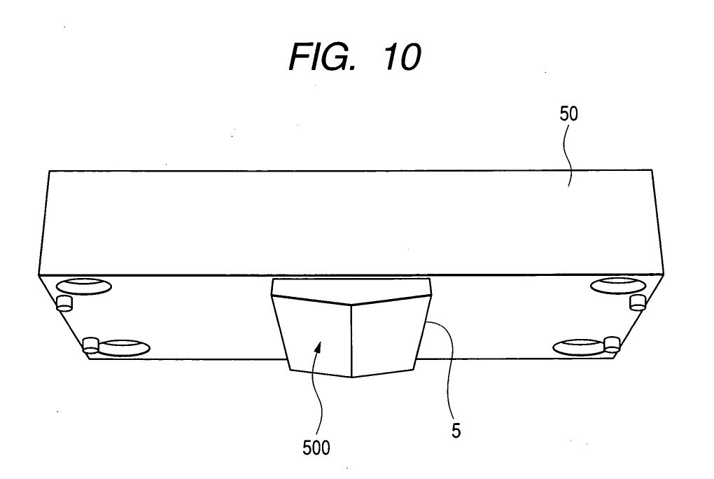

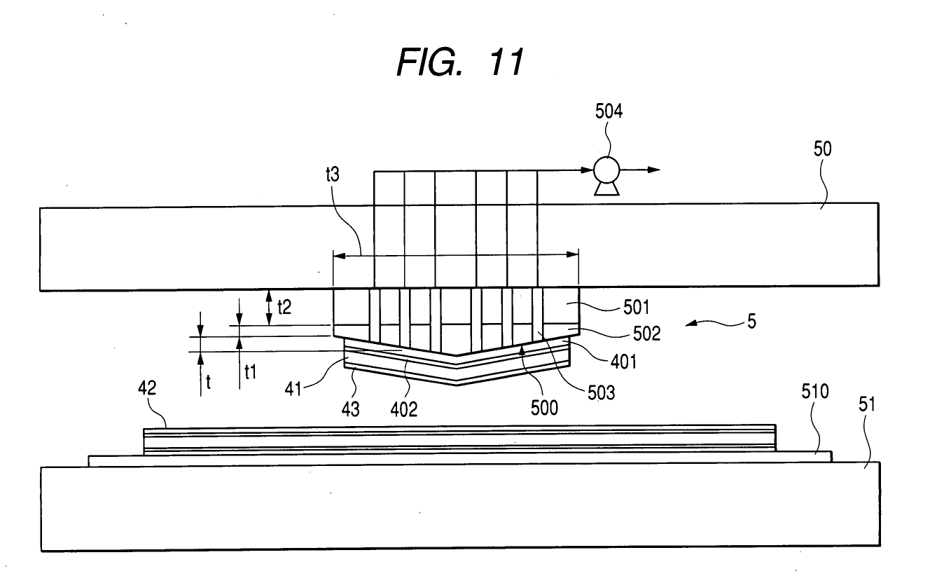

FIGS. 8A-8E and FIGS. 9A-9D show the processes for pressing and integrally laminating and bonding the first and second numerous-pieces-taken base sheets 41 and 42. FIGS. 10, 11, and 12 show the arrangement of an upper die 50 and an acute-angled elastic member 5. The upper die 50 has the acute-angled elastic member 5 opposing to a lower die 51. The acute-angled elastic member 5, as shown in FIG. 11, has an acute-angled surface 500 with a central region protruding toward the lower die 51 and right and left slant regions regressing obliquely from the central region to respective edge regions. The acute-angled elastic member 5 has a main body 501 and a slant portion 502. The main body 501 is made of a fluororubber (with the Shore hardness of 80). The slant portion 502 is made of a sponge (with the Shore hardness of 10).

Furthermore, the acute-angled elastic member 5 includes a plurality of suction holes 503 which extend vertically across the acute-angled elastic member 5 and are opened to the acute-angled surface 500 facing to the lower die 51. The suction holes 503 are connected to a pump 504.

In response to activation of the pump 504 the inside pressure of respective suction holes 503 decreases. A dense layer forming base sheet 401 and the first numerous-pieces-taken base sheet 41 are fixedly held on the acute-angled surface 500. The acute-angled elastic member 5 has the dimensions of t1=1 mm, t2=2 mm, t3=46 mm, and t=0.3 mm.

FIG. 16 shows a conventional upper die which is equipped with a flat elastic member 59. Both the dense layer forming base sheet 401 and the first numerous-pieces-taken base sheet 41 are laminated and disposed on this flat elastic member 59.

The integrally laminating and bonding operation according to this embodiment is performed in the following manner.

As shown in FIGS. 8A and 11, a laminate including the second numerous-pieces-taken base sheet 42 is disposed on a die surface 510 of the lower die 51. On the other hand, the dense layer forming base sheet 401, a bonding layer forming paste 402, the first numerous-pieces-taken base sheet 41, and the bonding layer forming paste 43 are successively disposed and held on the acute-angled surface 500 of the acute-angled elastic member 5 provided on the upper die 50. As shown in FIG. 9A, there is a clearance between the bonding layer forming paste 43 and the second numerous-pieces-taken base sheet 42. The bonding layer forming paste 43 has an uneven surface.

As shown in FIG. 8B, the upper die 50 is pressed toward the lower die 51. The bonding layer forming paste 43 and the second numerous-pieces-taken base sheet 42 are first brought into contact with each other at their central regions. In FIGS. 9B and 9C, arrows A and B indicate the pressing force acting on the bonding layer forming paste 43. The bonding layer forming paste 43 and the second numerous-pieces-taken base sheet 42 are locally brought into contact with each other at the region where the pressing force acts. The residual air is excluded from the region where the bonding layer forming paste 43 and the second numerous-pieces-taken base sheet 42 are newly brought into contact with each other. The excluded air is pushed toward the right and left edge portions as indicated by an arrow ‘m’, as shown in FIGS. 8C and 9C. Thus, the residual air successively moves to the right and left edge portions according to the progress of the pressing operation performed by the upper die 50.

Finally, as shown in FIG. 8D and also indicated by arrows A to C in FIG. 9D, the bonding layer forming paste 43 and the second numerous-pieces-taken base sheet 42 are entirely bonded. In this case, due to the edged shape of the acute-angled elastic member 5, the first numerous-pieces-taken base sheet 41 is bent into a V-shaped shape as shown in FIG. 8D. However, the assembled unit 4 according to this embodiment is cut into numerous pieces along the cutting line 49 (refer to FIG. 7). The V-shaped bent portion, corresponding to the central region of the assembled unit 4, is removed as waste.

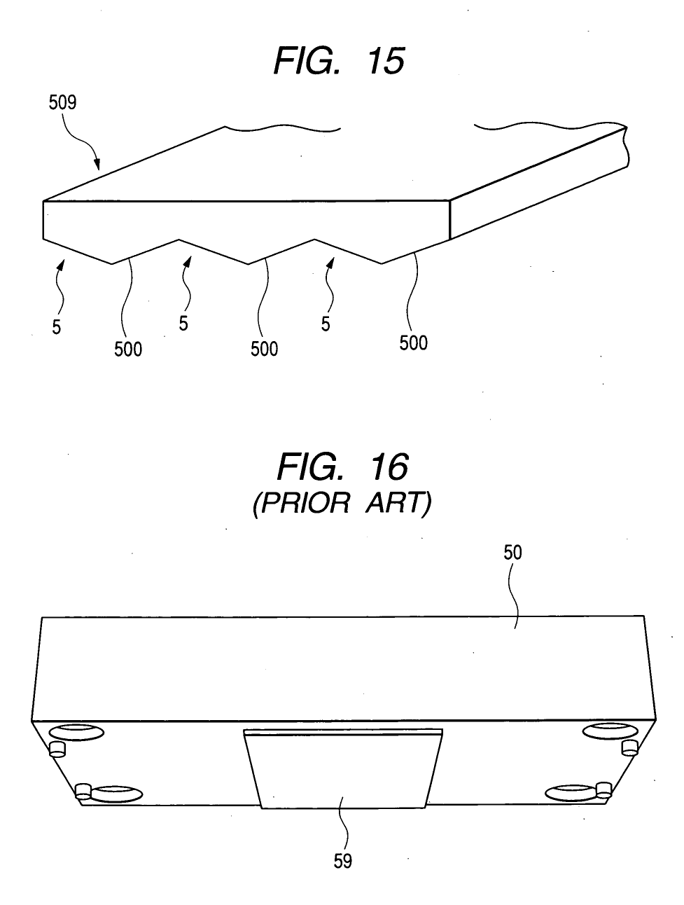

FIG. 13 is a perspective view showing another example of the acute-angled elastic member 5 having a curved acute-angled surface 500. FIG. 14 is a perspective view showing another example of the acute-angled elastic member 5 having a truncated acute-angled surface 500. FIG. 15 is a perspective view showing a different elastic member 509 consisting of sequentially connected acute-angled elastic members 5.

As described above, according to the manufacturing method this embodiment, in the process of integrally laminating and bonding the first and second numerous-pieces-taken base sheets 41 and 42 (refer to FIGS. 8A to 8E), the first numerous-pieces-taken base sheet 41 is first brought into contact with the second numerous-pieces-taken base sheet 42 at a portion facing to the central region of the acute-angled surface 500 of the upper die 50. Next, the first numerous-pieces-taken base sheet 41 and the second numerous-pieces-taken base sheet 42 contact with each other at the neighboring region adjacent to the central region of the acute-angled surface 500. The contact between the first and second numerous-pieces-taken base sheets 41 and 42 is successively delayed in accordance with a distance departing from the central region.

Accordingly, even if air bubbles remain in a space intervening between the bonding layer forming paste 43 and the second numerous-pieces-taken base sheet 42, the residual air bubbles are forcibly pushed out from the formerly pressed region to the later pressed region. According to the manufacturing method of this embodiment, the successive pressing operation advances symmetrically from the central region to the right and left edge portions of the acute-angled surface 500 of the upper die 50. The air bubbles residing in the central region are successively pushed out toward respective right and left edge portions, as shown in FIGS. 9A to 9D. As a result, the process of integrally laminating and bonding the first and second numerous-pieces-taken base sheets 41 and 42 can be accomplished with leaving substantially no air bubbles between them.

Accordingly, the manufacturing method of this embodiment can provide a multilayered gas sensing element containing substantially no air bubbles which increase the internal pressure of the bonding layer. Accordingly, the manufacturing method of this embodiment can obtain a multilayered gas sensing element which is capable of adequately retaining the internal pressure of the air bubbles and accordingly free from cracks and chips.

As apparent from the foregoing description, the second embodiment provides a second method for manufacturing a ceramic laminate according to a numerous-pieces-taken method. The ceramic laminate includes a first ceramic layer and a second ceramic layer which are laminated with each other via a bonding layer. The first ceramic layer has gas permeability. The second ceramic layer has gas impermeability. The numerous-pieces-taken method of this embodiment includes the following first to fifth steps. The first step is forming first and second numerous-pieces-taken base sheets for forming first and second ceramic layers. The second step is disposing the second numerous-pieces-taken base sheet on a lower die. The third step is disposing the first numerous-pieces-taken base sheet on a surface of an upper die, with a bonding layer forming paste coated beforehand on the first numerous-pieces-taken base sheet. The fourth step is pressing the upper die toward the lower die or pressing the lower die toward the upper die to obtain an integrated assembly of the first and second numerous-pieces-taken base sheets which are laminated and bonded together. And, the fifth step of dividing the integrated assembly into separate bodies and then sintering the separate bodies. According to this second manufacturing method, the surface of the upper die is an acute-angled surface with a central region protruding toward the lower die and right and left slant regions regressing obliquely from the central region to respective edge regions. In a process of integrally laminating and bonding the first and second numerous-pieces-taken base sheets, the acute-angled surface first presses a corresponding center of the second numerous-pieces-taken base sheet at the central region thereof. The acute-angled surface finally presses corresponding right and left edge portions of the second numerous-pieces-taken base sheet at the edge regions thereof, thereby successively pressing and integrating the first and second numerous-pieces-taken base sheets symmetrically from their central regions to respective right and left edge portions

### Third Embodiment

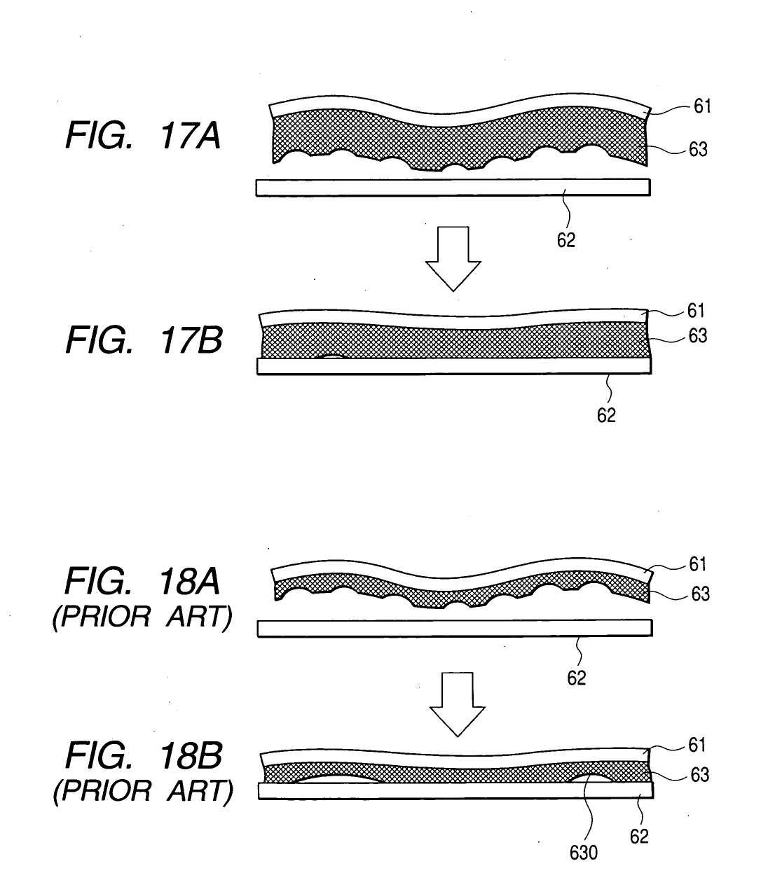

The third embodiment proposes a method for manufacturing a ceramic laminate. As shown in FIG. 17A, first and second ceramic layer forming green sheets 61 and 62 are formed. A bonding layer forming paste 63 is coated on the first ceramic layer forming green sheet 61 by the thickness of 60 μm. The second ceramic layer forming green sheet 62 is integrally laminated and bonded on the bonding layer forming paste 63 and then sintered together.

As a result, as shown in FIG. 17B, no air bubbles remain between the bonding layer 63 and the second ceramic layer forming green sheet 62.

As a comparative conventional example, as shown in FIG. 18A, the bonding layer forming paste 63 is coated on the first ceramic layer forming green sheet 61 by the thickness of 35 μm. Then, the second ceramic layer forming green sheet 62 is integrally laminated and bonded on the bonding layer forming paste 63. According to this conventional example, as shown in FIG. 18B, air bubbles 630 remain after the sintering is finished.

The amount of air bubbles remaining in the bonding layer is dependent on the uneven surface of the bonding layer forming paste. This embodiment proposes to coat the bonding layer forming paste 63 by a sufficient thickness. This is effective in suppressing the undulation of an assembly consisting of the first ceramic layer forming green sheet 61 and the bonding layer forming paste 63. As a result, it becomes possible to provide a flatten surface of the bonding layer forming paste 63 to be laminated on the second ceramic layer forming green sheet 62. Thus, no air bubbles reside between the bonding layer forming paste 63 and the second ceramic layer forming green sheet 62.

Accordingly, the manufacturing method of this embodiment can provide a ceramic laminate containing substantially no air bubbles which increase the internal pressure of the bonding layer. Accordingly, the manufacturing method of this embodiment can obtain a ceramic laminate which is capable of adequately retaining the internal pressure of the air bubbles and accordingly free from cracks and chips.

Regarding the pressing operation of the dies, it is desirable to bond two green sheets 61 and 62 via the bonding paste 63 successively from one end to the other end to exclude the residual air from their contact surfaces.

To realize this, the third embodiment successively laminates and bonds the first and second ceramic layer forming green sheets 61 and 62 in a single direction from one end region to the other end region. The residual air bubbles are forcibly pushed from the formerly pressed region to the later pressed region. As a result, the first ceramic layer forming green sheet 61 is integrally laminated and bonded with the bonding layer 63 coated on the second ceramic layer forming green sheet 62 without leaving any air bubbles between them.

In this respect, the third embodiment provides a third method for manufacturing a ceramic laminate including a first ceramic layer and a second ceramic layer which are laminated with each other via a bonding layer. The first ceramic layer has gas permeability. The second ceramic layer has gas impermeability. The third manufacturing method includes the following first to fifth steps. The first step is forming first and second ceramic layer forming green sheets. The second step is coating a bonding layer forming paste on the first ceramic layer forming green sheet. The third step is placing the first ceramic layer forming green sheet on the second ceramic layer forming green sheet. The fourth step is integrally laminating and bonding the first and second ceramic layer forming green sheets by successively pressing the first and second ceramic layer forming green sheets in a single direction from one end region to the other end region. And, the fifth step is sintering a laminated body including the first and second ceramic layer forming green sheets.

Furthermore, the thickness of the bonding layer forming paste 63 should be set somewhere in an optimized range. When the thickness of the bonding layer forming paste 63 is less than 5 μm, the expected effects of this embodiment will not be obtained. On the other hand, when the thickness of the bonding layer forming paste 63 is larger than 150 μm, the first and second ceramic layer forming green sheets 61 and 62 integrally assembled via the bonding layer forming paste 63 into a laminate will cause positional dislocation when this laminate is cut into separate pieces by a cutter.

Considering the above optimization with respect to the size of the bonding layer forming paste, the third embodiment provides a fourth method for manufacturing a ceramic laminate including a first ceramic layer having gas permeability and a second ceramic layer having gas impermeability which the following first to fourth steps. The first step is forming first and second ceramic layer forming green sheets. The second step is coating a bonding layer forming paste on the first ceramic layer forming green sheet by a thickness of 5 to 150 μm. The third step is integrally laminating and bonding the second ceramic layer forming green sheet on the bonding layer forming paste. And, the fourth step is sintering a laminated body including the first and second ceramic layer forming green sheets.

The inventors of this invention have experimentally manufactured multilayered gas sensing elements according to the manufacturing method of the second embodiment by using the upper die having the acute-angled elastic member shown in FIG. 11. For comparison, the inventors have manufactured multilayered gas sensing elements according to the manufacturing method of the second embodiment by using the conventional upper die having the flat elastic member shown in FIG. 16.

The inventors have prepared a plurality of acute-angled elastic members differentiated in the dimension of t (i.e. 0.3 mm, 0.5 mm, 0.8 mm, and 2 mm) in FIG. 11.

Furthermore, the pressing load applied between the upper die and the lower die is changed in three levels (i.e. 640N, 980N, 1280N).

The inventors have measured the pressure distribution in the laminate positioned between the upper die and the lower die by using an impact paper (turning red at the portion where the pressure is applied), in the flat elastic member as well as in the acute-angled elastic member.

The inventors have evaluated the measured result by using the five grades of AA, A, B, C, and D, wherein ‘AA’ represents excellent laminate pressure distribution and ‘A’ represents uniform distribution. The uniformity goes worse in the order of ‘B’, ‘C’ and ‘D’, wherein ‘D’ represents a condition that the load is concentrated to the center and a pressing force is insufficient at the edge regions.

Furthermore, in each of the multilayered gas sensing elements manufactured under various conditions, the inventors have checked the presence of air bubbles residing between the diffusion resistance layer and the bonding layer by monitoring a cut surface of each test element with an electron microscope. In this case, the inventors have evaluated the measured result by using the five grades of AA, A, B, C, and D, wherein ‘AA’ represents no air bubbles and the amount of air bubbles is small in the order of ‘A’, ‘B’, ‘C’, and ‘D’, wherein ‘D’ represents a condition that the amount of air bubbles is so large than cracks and chips appear due to increased internal pressure of the air bubbles.

Furthermore, the inventors have observed the appearance of respective multilayered gas sensing elements manufactured under various conditions. In this case, the inventors have evaluated the measured result by using the five grades of AA, A, B, C, and D, wherein ‘AA’ represents excellent appearance and the amount of press traces is small in the order of ‘A’, ‘B’, ‘C’, and ‘D.’ When the amount of press traces is large, the measured gas chamber may deform and accordingly the manufactured product will be removed as a defective.

Table 1 shows the measured result.

TABLE 1

| | | Flat | | | | |
|---|---|---|---|---|---|---|
| | | elastic | | | | |
| Press | | member | Acute-angled elastic member (FIG. 11) | | | |
| load | Condition | (FIG. 16) | T = 0.3 mm | t = 0.5 mm | t = 0.8 mm | t = 2 mm |
| 640N | L.P.D | AA | AA | AA | B | C |
| | Airbubbles | D | AA | AA | A | A |
| | Appearance | AA | AA | A | C | C |
| 980N | L.P.D | — | AA | B | — | — |
| | Air bubbles | — | AA | AA | — | — |
| | Appearance | — | AA | AA | — | — |
| 1280N | L.P.D | — | B | C | — | — |
| | Air bubbles | — | AA | B | — | — |
| | Appearance | — | AA | C | — | — |

L.P.D = laminate pressure distribution

As understood from the measured result shown in table 1, the multilayered gas sensing element manufactured by using the conventional upper die equipped with a flat elastic member (refer to FIG. 16) is undesirable in the durability because of a large amount of air bubbles remaining in the bonding layer. Increased internal pressure of the air bubbles possibly causes cracks and chips in the element. Meanwhile, it is confirmed that using the upper die equipped with the acute-angled elastic member is effective in obtaining multilayered gas sensing elements free from air bubbles.

Furthermore, the inventors have prepared multilayered gas sensing elements formed according to the manufacturing methods of the first to third embodiments. The inventors have prepared multilayered gas sensing elements formed according to the conventional manufacturing method explained in the first embodiment. The inventors have measured ‘total length of air bubbles’ and ‘residual platinum concentration’ in each test element. Regarding the coating thickness of the bonding layer forming paste, it is set to 60 μm in the case of the manufacturing method according to the third embodiment and is otherwise set to the same value of 35 μm.

Furthermore, a total of 12 test elements are experimentally manufactured according to each manufacturing method.

To obtain the total length of air bubbles, the inventors have measured the length of each air bubble observed on a cut surface of each multilayered gas sensing element, taken along a cross section shown in FIG. 2, with an electron microscope. The length of each air bubble represents the size of each air bubble measured in the width direction of each test element. The total length of air bubbles represents a sum of lengths of measured air bubbles.

The measurement of residual platinum concentration was performed in the following manner.

Each test element is soaked in a chloroplatinic acid solution for ten minutes and then dried, so that the diffusion resistance layer can carry chloroplatinum. Next, the test element is soaked in the water for ten minutes and then dried. The chloroplatinum carried in the diffusion resistance layer is introduced together with the water into air bubbles. When there is no passage connecting the diffusion resistance layer and the air bubbles, no chloroplatinum enters into the air bubbles. The introduced amount is dependent on the degree of communication between the diffusion resistance layer and the air bubbles. After that, the test element is cut to expose the undulation (i.e. recesses forming the air bubbles) on a cut surface. The platinum amount (in the units of k %) is measured based. on EPMA (Electron Probe Micro Analysis).

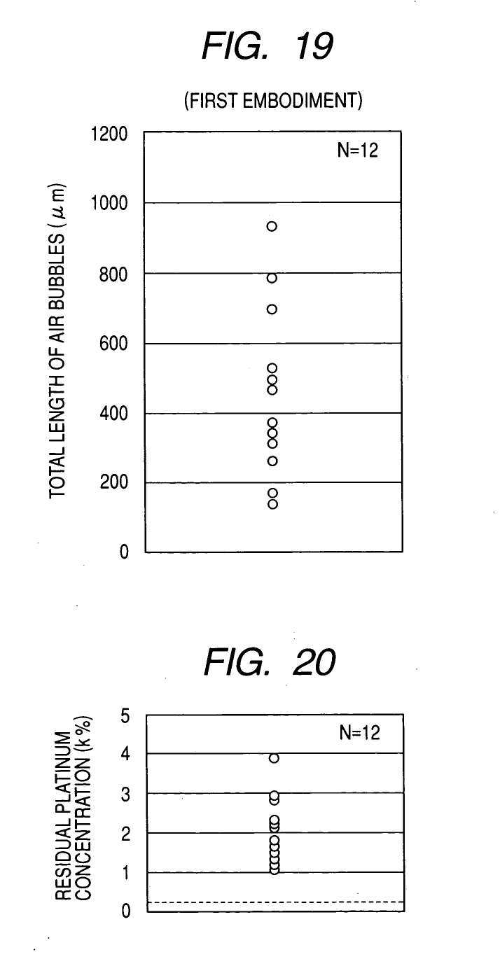

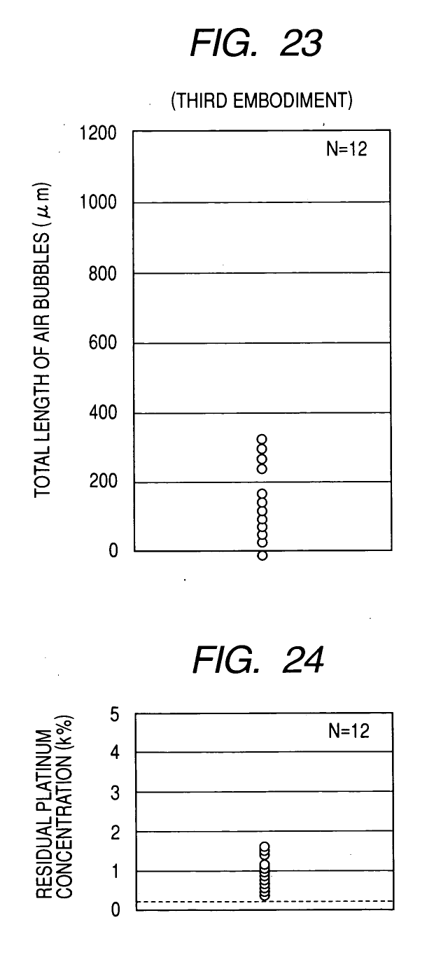

FIGS. 19 to 26 respectively show the measured result.

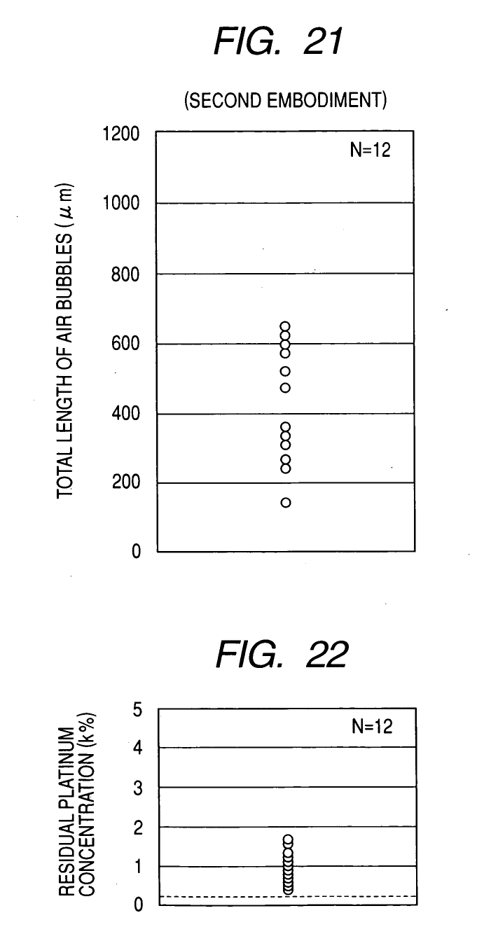

As understood from FIGS. 21, 23 and 25, the total length of air bubbles according to the second and third embodiments distributes in a narrow range compared with the total length of air bubbles according to a conventional manufacturing method.

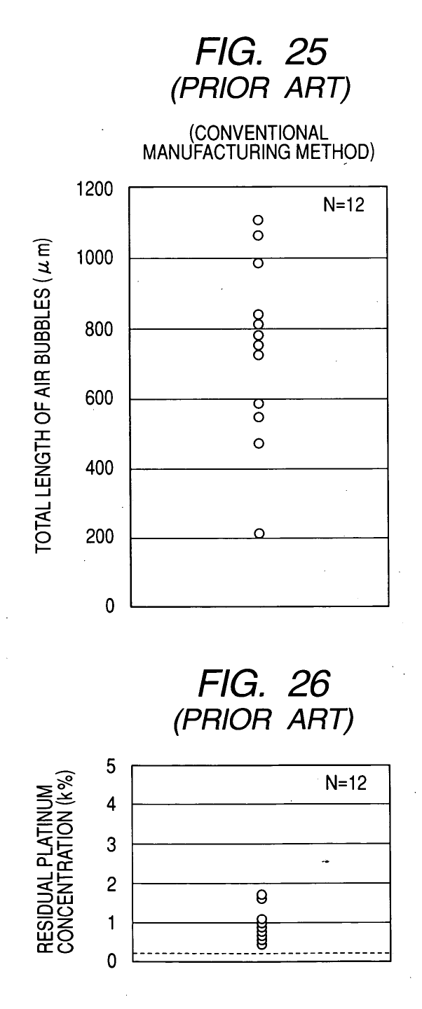

As understood from FIGS. 19 and 25, the total length of air bubbles according to the manufacturing method of the first embodiment is not so different from the total length of air bubbles according to the conventional manufacturing method. However, it is confirmed based on the observation using an electron microscope that air bubbles chiefly reside between the diffusion resistance layer and the bonding layer according to the manufacturing method of the first embodiment. On the contrary, air bubbles chiefly reside between the measured gas chamber defining spacer and the bonding layer according to conventional manufacturing method.

Furthermore, as understood from FIG. 20, the residual platinum concentration is very high according to the test element manufactured according to the first embodiment because the air bubbles are exposed to the diffusion resistance layer (refer to FIG. 4). As understood from FIGS. 22, 24 and 26, the residual platinum concentration in the test elements manufactured according to the manufacturing method of the second and third embodiments is shifted to a lower side compared with the test element manufactured according to the conventional manufacturing method. In short, compared with the conventional manufacturing method, the chloroplatinum cannot enter into the air bubbles.

Subsequently, the inventors have experimentally manufactured a great amount of test elements according to the manufacturing methods of the first to third embodiments and according to the conventional manufacturing method described in the first embodiment. The inventors have conducted ‘water absorption debugging’ and ‘vacuum/water absorption debugging’ tests for each test element to check the presence of chipping (i.e. cracks and chips) generated in the test element. The element including any chipping is a defective.

The inventors have conducted the ‘water absorption debugging’ test in the following manner.

Each test element is soaked in the water for 10 minutes and then dried. When the test element cannot show desirable sensor characteristics under a condition that a voltage of 14.5V is applied to the test element, it is concluded that this test element has cracks and chips and is accordingly defective.

The inventors have conducted the ‘vacuum/water absorption debugging’ test in the following manner.

Each test element is soaked in the water for 10 minutes under a depressurized condition of 0.1 atm. Then, the test element is dried in the air. The presence of chipping is checked under application of 14.5V.

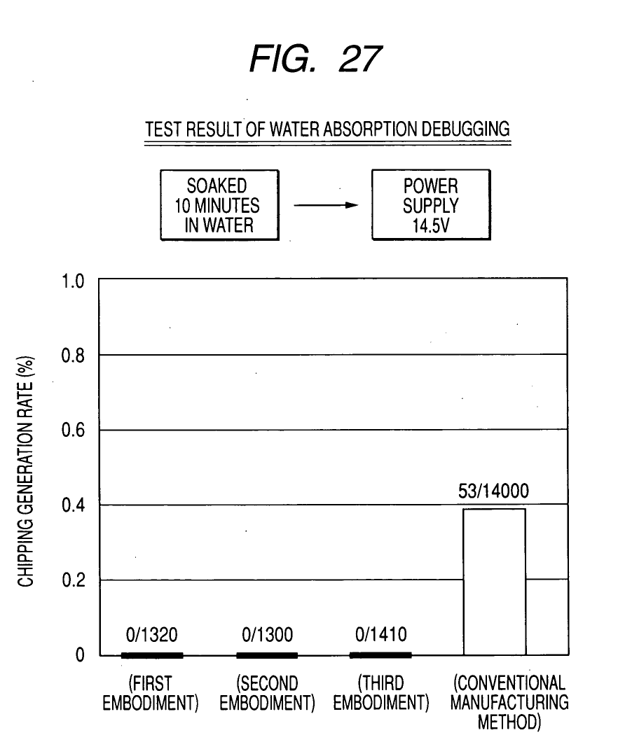

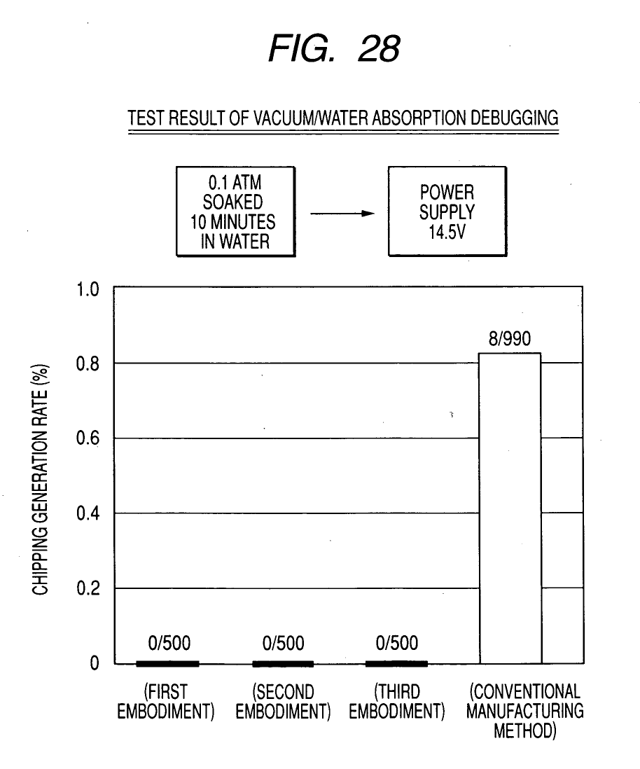

FIG. 27 shows the test result of conducted water absorption debugging. FIG. 28 shows the test result of conducted vacuum/water absorption debugging. In both debugging tests, the inventors have confirmed the presence of chipping in the test elements manufactured according to the conventional manufacturing method. The inventors have confirmed no chipping in the test elements manufactured according to the manufacturing method of the first to third embodiments.

From the above test result, the inventors have confirmed that each of the second and third embodiments can provide a manufacturing method which is capable of reducing the amount of residual air bubbles compared with the conventional manufacturing method. The water vapor cannot enter into the air bubbles. Accordingly, the internal pressure of the air bubbles does not increase. The amount of water vapor entering into the air bubbles is small. As a result, an excellent multilayered gas sensing element is obtained.

According to the manufacturing method of the first embodiment, air bubbles are exposed to the diffusion resistance layer. This arrangement is effective in suppressing increase of the internal pressure in the air bubbles irrespective of the amount of air bubbles and invasion of the water vapor. As a result, an excellent multilayered gas sensing element is obtained

### Fourth Embodiment

This embodiment relates to a multilayered gas sensing element similar in arrangement with that of the first embodiment shown in FIGS. 1 and 2. The multilayered gas sensing element according to the fourth embodiment further includes a shielding layer 141 disposed between the gas permeable diffusion resistance layer 14 and the bonding layer 3. The shielding layer 141 has the porosity lower than that of the diffusion resistance layer 14. The porosity of the shielding layer 14 is substantially equal to the porosity of the dense layer 15.

The shielding layer 141 is 15 μm in thickness and 2% in porosity. The shielding layer 141 is made of an alumina ceramic. The diffusion resistance layer 14 is also made of an alumina ceramic.

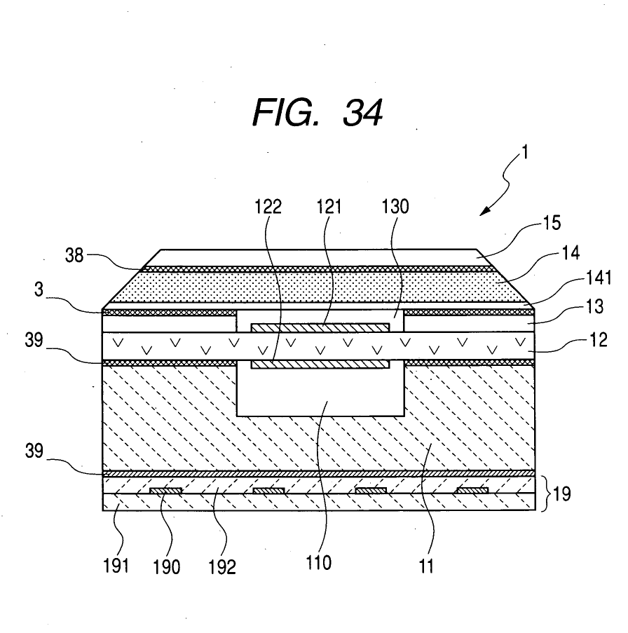

The artisans in the art will be able to readily understand the shielding layer 141 of this embodiment based on the illustration shown in FIGS. 1 and 2, since additionally required depiction to the drawing is simply adding the shielding layer 141 of this embodiment between the diffusion resistance layer 14 and the bonding layer 3. FIG. 34 gives the illustration for the fourth embodiment.

The inventors have performed the following measurement for each of the element manufactured according to this embodiment and the element manufactured according to the conventional manufacturing method disclosed in the first embodiment.

Each test element is soaked in a chloroplatinic acid solution for ten minutes under a depressurized condition of 0.1 atm. Then, the test element is dried so that the diffusion resistance layer can carry chloroplatinum. Next, the test element is soaked in the water for ten minutes and then dried. The chloroplatinum carried in the diffusion resistance layer is introduced together with the water into air bubbles in the bonding layer. After that, the test element is cut to expose the air bubbles on a cut surface. The platinum amount (in the units of k %) is measured based on EPMA (Electron Probe Micro Analysis).

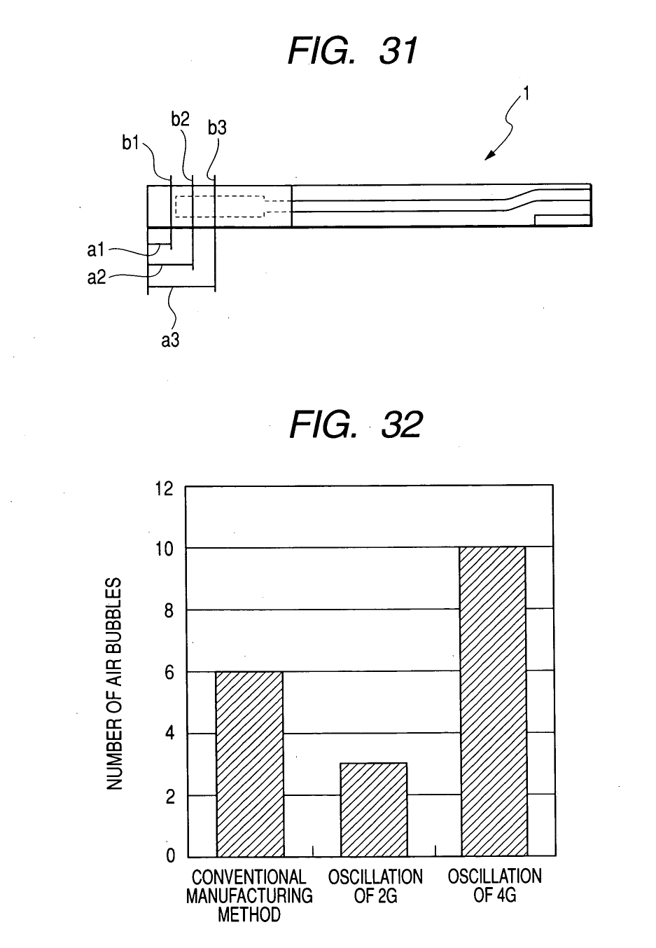

As shown in FIG. 31, the test element is cut along a plurality of cutting lines b1, b2 and b3 perpendicular to the longitudinal direction of the test element. A distance a1 between the cutting line b1 and the edge of the element is 3 mm. A distance a2 between the cutting line b2 and the edge of the element is 6 mm. And, a distance a3 between the cutting line b3 and the edge of the element is 9 mm. The length of air bubbles is measured on each cut surface.

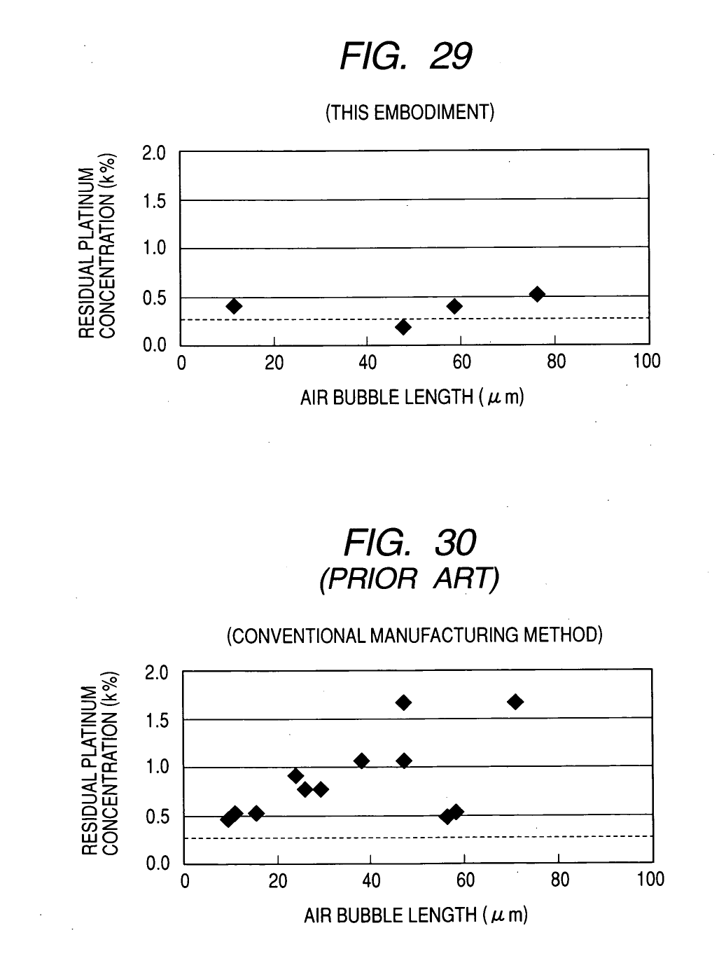

As a result, the inventors have found a total of four air bubbles on the above three cut surfaces of the multilayered gas sensing element manufactured according to this embodiment. On the other hand, the inventors have found a total of twelve air bubbles on the above three cut surfaces of the multilayered gas sensing element manufactured according to the conventional manufacturing method. FIG. 29 shows the measured relationship between the length of each air bubble and the residual platinum concentration according to this embodiment. FIG. 30 shows the measured relationship between the length of each air bubble and the residual platinum concentration according to the conventional manufacturing method.

As understood from the comparison between the data shown in FIGS. 29 and 30, the number of residual air bubbles is small according to the element manufactured according to this embodiment. The shielding layer prevents the chloroplatinum from moving from the diffusion resistance layer. The residual platinum concentration in respective air bubbles is small. The number of air bubbles is large according to the element manufactured according to the conventional manufacturing method. The residual platinum concentration in respective air bubbles is large.

Providing the shielding layer effectively prevents the water vapor from entering into the air bubbles. This prevents condensed water vapor from increasing the internal pressure of the air bubbles.

As apparent from the foregoing description, the fourth embodiment provides a fifth method for manufacturing a ceramic laminate including a first ceramic layer and a second ceramic layer which are laminated with each other via a bonding layer. The first ceramic layer has gas permeability. The second ceramic layer has gas impermeability. The fifth manufacturing method includes a step of providing a shielding layer between the first ceramic layer and the bonding layer. The shielding layer has the porosity lower than that of the first ceramic layer.

### Fifth Embodiment

The fifth embodiment relates to a method for manufacturing a multilayered gas sensing element by using the conventional upper die equipped with the flat elastic member shown in FIG. 16. The fifth embodiment further includes a diaphragm (not shown in the drawing) attached to the upper die. According to this embodiment, the diaphragm is oscillated when the upper die is pressed toward the lower die in the process of integrally laminating and bonding the sheets into an assembled unit.

The inventors have evaluated a test element manufactured according to this embodiment and a test element manufactured by using the conventional upper die equipped with the flat elastic member shown in FIG. 16.

Like the fourth embodiment shown in FIG. 31, each test element is cut along a total of three cutting lines b1, b2 and b3 perpendicular to the longitudinal direction of the test element. The inventors have measured the number of air bubbles found on each cut surface. FIG. 32 shows the measured result. The inventors have confirmed that oscillating the diaphragm at the acceleration 2 G is effective in reducing the total number of air bubbles. However, raising the oscillation level to 4 G will bring no expected effects compared with the test element manufactured by using the conventional upper die equipped with the flat elastic member shown in FIG. 16

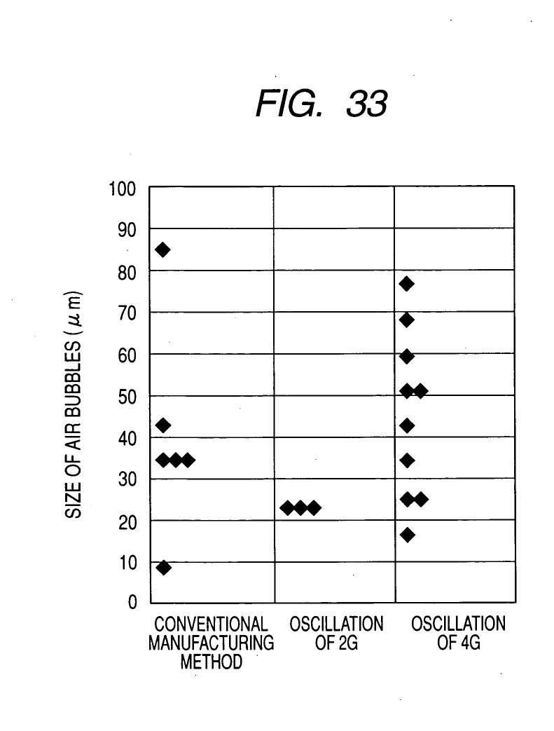

FIG. 33 shows the distribution with respect to the size (diameter) of air bubbles. As understood from FIG. 33, adding the oscillation of 2 G is effective in reducing the size of air bubbles. However, raising the oscillation level to 4 G will bring no expected effects. In this manner, this embodiment can provide an excellent ceramic element.

The place where the diaphragm is installed is not limited to the upper die. For example, the diaphragm can be attached to the lower die.

In this respect, the fifth embodiment provides a sixth method for manufacturing a ceramic laminate including a first ceramic layer and a second ceramic layer which are laminated with each other via a bonding layer. The first ceramic layer has gas permeability. The second ceramic layer has gas impermeability. This sixth manufacturing method includes the following first to fifth steps. The first step is forming first and second ceramic layer forming green sheets. The second step is disposing the second ceramic layer forming green sheet on a lower die. The third step is disposing the first ceramic layer forming green sheet on an upper die with a bonding layer forming paste coated beforehand on the first ceramic layer forming green sheet. The fourth step is pressing the upper die toward the lower die or pressing the lower die toward the upper die to obtain an integrated assembly of the first and second ceramic layer forming green sheets which are laminated and bonded together, while oscillating a diaphragm disposed on the upper die or the lower die. And, the fifth step is sintering the integrated assembly of the first and second ceramic layer forming green sheets.

1. A method for manufacturing a ceramic laminate including a first ceramic layer having gas permeability and a second ceramic layer having gas impermeability which are laminated with each other via a bonding layer, said manufacturing method comprising the steps of:
forming first and second ceramic layer forming green sheets,
coating a bonding layer forming paste on said second ceramic layer forming green sheet, and
integrally bonding said first ceramic layer forming green sheet with said bonding layer forming paste into a laminated body and then sintering said laminated body.

2. A method for manufacturing a ceramic laminate according to a numerous-pieces-taken method, said ceramic laminate including a first ceramic layer having gas permeability and a second ceramic layer having gas impermeability which are laminated with each other via a bonding layer, said numerous-pieces-taken method comprising the steps of:
forming first and second numerous-pieces-taken base sheets for forming first and second ceramic layers;
disposing said second numerous-pieces-taken base sheet on a lower die;
disposing said first numerous-pieces-taken base sheet on a surface of an upper die, with a bonding layer forming paste coated beforehand on said first numerous-pieces-taken base sheet;
pressing said upper die toward said lower die or pressing said lower die toward said upper die to obtain an integrated assembly of said first and second numerous-pieces-taken base sheets which are laminated and bonded together; and
dividing said integrated assembly into separate bodies and then sintering the separate bodies,
wherein the surface of said upper die is an acute-angled surface with a central region protruding toward said lower die and right and left slant regions regressing obliquely from said central region to respective edge regions; and
in a process of integrally laminating and bonding said first and second numerous-pieces-taken base sheets, said acute-angled surface first presses a corresponding center of said second numerous-pieces-taken base sheet at said central region thereof, and said acute-angled surface finally presses corresponding right and left edge portions of said second numerous-pieces-taken base sheet at said edge regions thereof, thereby successively pressing and integrating said first and second numerous-pieces-taken base sheets symmetrically from their central regions to respective right and left edge portions.

3. A method for manufacturing a ceramic laminate including a first ceramic layer having gas permeability and a second ceramic layer having gas impermeability which are laminated with each other via a bonding layer, said method comprising the steps of:
forming first and second ceramic layer forming green sheets;
coating a bonding layer forming paste on said first ceramic layer forming green sheet;
placing said first ceramic layer forming green sheet on said second ceramic layer forming green sheet;
integrally laminating and bonding said first and second ceramic layer forming green sheets by successively pressing said first and second ceramic layer forming green sheets in a single direction from one end region to the other end region; and
sintering a laminated body of said first and second ceramic layer forming green sheets.

4. A method for manufacturing a ceramic laminate including a first ceramic layer having gas permeability and a second ceramic layer having gas impermeability which are laminated with each other via a bonding layer, said method comprising the steps of:
forming first and second ceramic layer forming green sheets;
coating a bonding layer forming paste on said first ceramic layer forming green sheet by a thickness of 5 to 150 μm;
integrally laminating and bonding said second ceramic layer forming green sheet on said bonding layer forming paste; and
sintering a laminated body of said first and second ceramic layer forming green sheets.

5. A method for manufacturing a ceramic laminate including a first ceramic layer having gas permeability and a second ceramic layer having gas impermeability which are laminated with each other via a bonding layer, said method comprising the step of:
providing a shielding layer between said first ceramic layer and said bonding layer, said shielding layer having the porosity lower than that of said first ceramic layer.

6. The ceramic laminate manufacturing method in accordance with claim 5, wherein the porosity of said shielding layer is equal to or less than 2%.

7. A method for manufacturing a ceramic laminate including a first ceramic layer having gas permeability and a second ceramic layer having gas impermeability which are laminated with each other via a bonding layer, said method comprising the steps of:
forming first and second ceramic layer forming green sheets;
disposing said second ceramic layer forming green sheet on a lower die;
disposing said first ceramic layer forming green sheet on an upper die with a bonding layer forming paste coated beforehand on said first ceramic layer forming green sheet;
pressing said upper die toward said lower die or pressing said lower die toward said upper die to obtain an integrated assembly of said first and second ceramic layer forming green sheets which are laminated and bonded together, while oscillating a diaphragm disposed on said upper die or said lower die; and
sintering said integrated assembly of said first and second ceramic layer forming green sheets.

8. A method for manufacturing a multilayered gas sensing element for detecting the concentration of a specific gas contained in a measured gas, said multilayered gas sensing element including a first ceramic layer having gas permeability and a second ceramic layer having gas impermeability which are laminated with each other via a bonding layer, said method comprising the steps of:
forming first and second ceramic layer forming green sheets,
coating a bonding layer forming paste on said second ceramic layer forming green sheet, and
integrally bonding said first ceramic layer forming green sheet with said bonding layer forming paste into a laminated body and then sintering said laminated body.

9. A method for manufacturing a multilayered gas sensing element for detecting the concentration of a specific gas contained in a measured gas, said multilayered gas sensing element being manufactured according to a numerous-pieces-taken method, said multilayered gas sensing element including a first ceramic layer having gas permeability and a second ceramic layer having gas impermeability which are laminated with each other via a bonding layer, said numerous-pieces-taken method comprising the steps of:
forming first and second numerous-pieces-taken base sheets for forming first and second ceramic layers;
disposing said second numerous-pieces-taken base sheet on a lower die;
disposing said first numerous-pieces-taken base sheet on a surface of an upper die, with a bonding layer forming paste coated beforehand on said first numerous-pieces-taken base sheet;
pressing said upper die toward said lower die or pressing said lower die toward said upper die to obtain an integrated assembly of said first and second numerous-pieces-taken base sheets which are laminated and bonded together; and
dividing said integrated assembly into separate bodies and then sintering the separate bodies,
wherein the surface of said upper die is an acute-angled surface with a central region protruding toward said lower die and right and left slant regions regressing obliquely from said central region to respective edge regions; and
in a process of integrally laminating and bonding said first and second numerous-pieces-taken base sheets, said acute-angled surface first presses a corresponding center of said second numerous-pieces-taken base sheet at said central region thereof, and said acute-angled surface finally presses corresponding right and left edge portions of said second numerous-pieces-taken base sheet at said edge regions thereof, thereby successively pressing and integrating said first and second numerous-pieces-taken base sheets symmetrically from their central regions to respective right and left edge portions.

10. A method for manufacturing a multilayered gas sensing element for detecting the concentration of a specific gas contained in a measured gas, said multilayered gas sensing element including a first ceramic layer having gas permeability and a second ceramic layer having gas impermeability which are laminated with each other via a bonding layer, said method comprising the steps of:
forming first and second ceramic layer forming green sheets;
coating a bonding layer forming paste on said first ceramic layer forming green sheet;
placing said first ceramic layer forming green sheet on said second ceramic layer forming green sheet;
integrally laminating and bonding said first and second ceramic layer forming green sheets by successively pressing said first and second ceramic layer forming green sheets in a single direction from one end region to the other end region; and
sintering a laminated body of said first and second ceramic layer forming green sheets.

11. A method for manufacturing a multilayered gas sensing element for detecting the concentration of a specific gas contained in a measured gas, said multilayered gas sensing element including a first ceramic layer having gas permeability and a second ceramic layer having gas impermeability which are laminated with each other via a bonding layer, said method comprising the steps of:
forming first and second ceramic layer forming green sheets;
coating a bonding layer forming paste on said first ceramic layer forming green sheet by a thickness of 5 to 150 μm;
integrally laminating and bonding said second ceramic layer forming green sheet on said bonding layer forming paste; and
sintering a laminated body of said first and second ceramic layer forming green sheets.

12. A method for manufacturing a multilayered gas sensing element for detecting the concentration of a specific gas contained in a measured gas, said multilayered gas sensing element including a first ceramic layer having gas permeability and a second ceramic layer having gas impermeability which are laminated with each other via a bonding layer, said method comprising the step of:
providing a shielding layer between said first ceramic layer and said bonding layer, said shielding layer having the porosity lower than that of said first ceramic layer.

13. A method for manufacturing a multilayered gas sensing element for detecting the concentration of a specific gas contained in a measured gas, said multilayered gas sensing element including a first ceramic layer having gas permeability and a second ceramic layer having gas impermeability which are laminated with each other via a bonding layer, said method comprising the steps of:
forming first and second ceramic layer forming green sheets;
disposing said second ceramic layer forming green sheet on a lower die;
disposing said first ceramic layer forming green sheet on an upper die with a bonding layer forming paste coated beforehand on said first ceramic layer forming green sheet;
pressing said upper die toward said lower die or pressing said lower die toward said upper die to obtain an integrated assembly of said first and second ceramic layer forming green sheets which are laminated and bonded together, while oscillating a diaphragm disposed on said upper die or said lower die; and
sintering said integrated assembly of said first and second ceramic layer forming green sheets.

14. A ceramic laminate comprising a first ceramic layer having gas permeability and a second ceramic layer having gas impermeability which are laminated with each other via a bonding layer, wherein no air bubbles reside along a boundary between said bonding layer and said second ceramic layer and air bubbles reside along a boundary between said bonding layer and said first ceramic layer.

15. The ceramic laminate in accordance with claim 14, wherein said air bubbles reside in a space defined between a recess of a surface of said bonding layer and said first ceramic layer.

16. A multilayered gas sensing element for detecting the concentration of a specific gas in a measured gas, wherein
said multilayered gas sensing element includes a ceramic laminate comprising a first ceramic layer having gas permeability and a second ceramic layer having gas impermeability which are laminated with each other via a bonding layer,
no air bubbles reside along a boundary between said bonding layer and said second ceramic layer and air bubbles are present along a boundary between said bonding layer and said first ceramic layer.
